(19) United States
(12) Patent Application Publication
(10) Pub. No.: US 2026/0254983 A1
(43) Pub. Date: Aug. 27, 2026

(54) POINT CLOUD DECODING DEVICE, POINT CLOUD DECODING METHOD, AND NON-TRANSITORY COMPUTER-READABLE MEDIUM

(71) Applicant: KDDI CORPORATION, Tokyo (JP)

(72) Inventors: Youhei HANAOKA, Fujimino-shi (JP); Kyohei UNNO, Fujimino-shi (JP); Chihiro NAKATSUKA, Fujimino-shi (JP); Keisuke NONAKA, Fujimino-shi (JP); Kei KAWAMURA, Fujimino-shi (JP)

(73) Assignee: KDDI CORPORATION, Tokyo (JP)

(21) Appl. No.: 19/553,619

(22) Filed: Mar. 2, 2026

Related U.S. Application Data
(63) Continuation of application No. PCT/JP2024/008608, filed on Mar. 6, 2024.

(30) Foreign Application Priority Data
Oct. 5, 2023 (JP) 2023-173790

(51) Int. Cl. H04N 19/44; H04N 19/31; H04N 19/597; H04N 19/70

(52) U.S. Cl. CPC H04N 19/44; H04N 19/31; H04N 19/597; H04N 19/70

(57) ABSTRACT

A point cloud decoding device 200 includes: a RAHT unit 2080 configured to, in inter prediction of an AC coefficient of RAHT, apply a scaling factor to a predicted value of the AC coefficient or a predicted value of an attribute value; and an attribute information decoding unit 2060 configured to derive the number of scaling factors to be used in the inter prediction and decode as many scaling factors as the number.

### CROSS-REFERENCE TO RELATED APPLICATIONS

The present application is a continuation of PCT Application No. PCT/JP2024/008608, filed on Mar. 6, 2024, which claims the benefit of Japanese patent application No. 2023-173790 filed on Oct. 5, 2023, the entire contents of each application being incorporated herein by reference in its entirety.

### TECHNICAL FIELD

The present invention relates to a point cloud decoding device, a point cloud decoding method, and a non-transitory computer-readable medium.

### BACKGROUND ART

Conventionally, in decoding attribute information, a method is known in which an AC coefficient of an attribute value is inter-predicted, the inter-predicted value is scaled by using a scaling factor, a residual of the scaled inter-predicted value and the decoded AC coefficient is added, the AC coefficient is reconstructed, and the attribute value is decoded by inverse RAHT.

However, in the related art, since there is one scaling factor for each Octree hierarchy, there is a problem that the value of the scaling factor is not optimized.

Therefore, the present invention has been made in view of the above-described problems, and an object thereof is to provide a point cloud decoding device, a point cloud decoding method, and a program, which can improve the encoding efficiency of encoding attribute information.

A first aspect of the present invention is a point cloud decoding device including a RAHT unit that performs scaling on an intra-predicted value of an AC coefficient by a scaling factor different for each Octree hierarchy and for each frequency index of the AC coefficient.

A second aspect of the present invention is a point cloud decoding method including a process of performing scaling on an intra-predicted value of an AC coefficient by a scaling factor different for each Octree hierarchy and for each frequency index of the AC coefficient.

A third aspect of the present invention is a program for causing a computer to function as a point cloud decoding device, in which the point cloud decoding device includes a RAHT unit that performs scaling on an intra-predicted value of an AC coefficient by a scaling factor different for each Octree hierarchy and for each frequency index of the AC coefficient.

A fourth aspect of the present invention is a point cloud decoding device including an attribute information decoding unit that derives the number of scaling factors in inter prediction on the basis of a syntax specifying a hierarchy to which decoded inter prediction is applied.

According to the present invention, it is possible to provide a point cloud decoding device, a point cloud decoding method, and a program, which can improve the encoding efficiency of encoding attribute information.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to an embodiment.

FIG. 3 is a diagram illustrating an example of a configuration of encoded data (bit stream) received by a geometry information decoding unit 2010 of the point cloud decoding device 200 according to an embodiment.

FIG. 4 is a diagram illustrating an example of a syntax configuration of a GPS 2011.

FIG. 5 is a diagram illustrating an example of a configuration of encoded data (bit stream) received by an attribute-information decoding unit 2060 of the point cloud decoding device 200 according to an embodiment.

FIG. 6 illustrates an example of a syntax configuration of an APS 2611 illustrated in FIG. 5.

FIG. 7 is a flowchart illustrating an example of processing of an RAHT unit 2080.

FIG. 8 is a flowchart illustrating an example of processing in step S28004.

FIG. 9 is a flowchart illustrating an example of processing in step S28104.

FIG. 10 is a flowchart illustrating an example of processing of intra prediction in step S28112.

FIG. 11 is a diagram illustrating a relationship between a decoding target node and an adjacent node in a higher-level hierarchy.

FIG. 12 is a diagram illustrating a relationship between a decoding target node and an adjacent node in a subnode hierarchy.

FIG. 13 is a flowchart illustrating an example of processing of intra prediction in step S28112.

FIG. 14 is a flowchart illustrating an example of processing of the RAHT unit 2080.

FIG. 15 is a diagram illustrating an example of inter prediction processing in step S28111.

FIG. 16 is a flowchart illustrating an example of operation of the tree synthesizing unit 2020 of the point cloud decoding device 200 according to an embodiment.

FIG. 17 is a flowchart illustrating an example of processing of decoding predictor information and a spherical coordinate residual in step S1604.

FIG. 18 is a diagram illustrating an example of functional blocks of the point cloud encoding device 100 according to an embodiment.

FIG. 19 is a diagram for describing modified example 1.

FIG. 20 is a diagram for describing modified example 2.

FIG. 21 is a diagram for describing modified example 2.

FIG. 22 is a diagram for describing modified example 2.

FIG. 23 is a diagram for describing modified example 2.

FIG. 24 is a diagram for describing modified example 2.

FIG. 25 is a diagram for describing modified example 2.

FIG. 26 is a diagram for describing modified example 3.

FIGS. 27A and 27B are diagrams for describing modified example 3.

FIG. 28 is a diagram for describing modified example 3.

FIGS. 29A and 29B are diagrams for describing modified example 3.

FIGS. 30A and 30B are diagrams for describing modified example 3.

FIGS. 31A and 31B are diagrams for describing modified example 3.

FIGS. 32A and 32B are diagrams for describing modified example 3.

FIG. 33 is a diagram for describing modified example 3.

FIG. 34 is a diagram for describing modified example 3.

### DETAILED DESCRIPTION

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

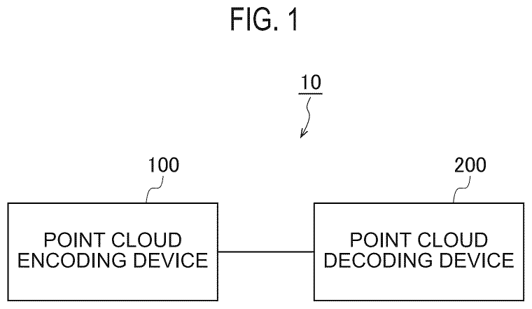

Hereinafter, a point cloud processing system 10 according to a first embodiment of the present invention will be described with reference to FIGS. 1 to 18. FIG. 1 is a diagram illustrating the point cloud processing system 10 according to an embodiment of the present embodiment.

As illustrated in FIG. 1, the point cloud processing system 10 includes a point cloud encoding device 100 and a point cloud decoding device 200.

The point cloud encoding device 100 is configured to generate encoded data (bit stream) by encoding an input point cloud signal. The point cloud decoding device 200 is configured to generate an output point cloud signal by decoding the bit stream.

Note that the input point cloud signal and the output point cloud signal include position information and attribute information of each point in a point cloud. The attribute information is, for example, color information or a reflection ratio of each point.

Here, such a bit stream may be transmitted from the point cloud encoding device 100 to the point cloud decoding device 200 through a transmission path. Furthermore, the bit stream may be stored in a storage medium, and then provided from the point cloud encoding device 100 to the point cloud decoding device 200.

### (Point Cloud Decoding Device 200)

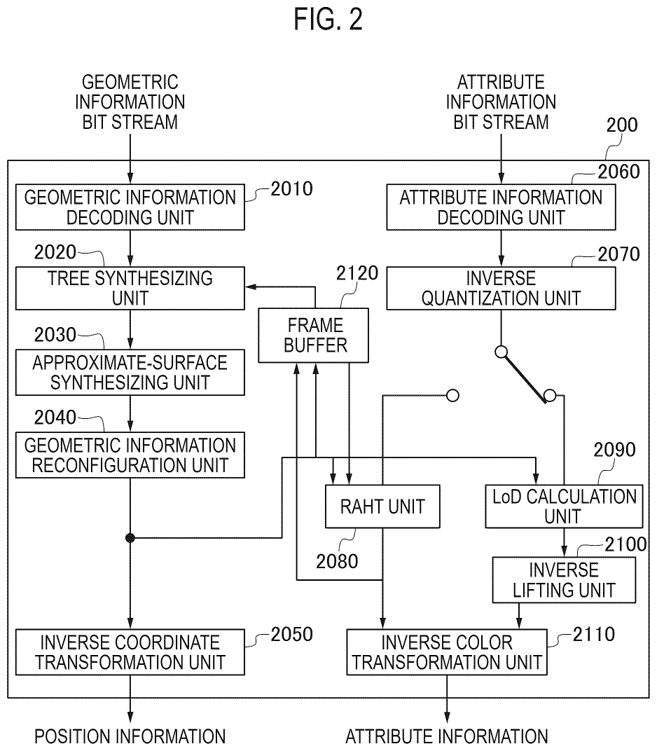

Hereinafter, the point cloud decoding device 200 according to the present embodiment will be described with reference to FIG. 2. FIG. 2 is a diagram illustrating an example of functional blocks of the point cloud decoding device 200 according to the present embodiment.

As illustrated in FIG. 2, the point cloud decoding device 200 includes a geometry information decoding unit 2010, a tree synthesizing unit 2020, an approximate-surface synthesizing unit 2030, a geometry information reconfiguration unit 2040, an inverse coordinate transformation unit 2050, an attribute-information decoding unit 2060, an inverse quantization unit 2070, a region adaptive hierarchical transform (RAHT) unit 2080, a level-of-detail (LoD) calculation unit 2090, an inverse lifting unit 2100, an inverse color transformation unit 2110, and a frame buffer 2120.

The geometry information decoding unit 2010 is configured to use, as input, a bit stream about geometry information (geometry information bit stream) among bit streams output from the point cloud encoding device 100, and to decode syntax.

Decoding processing is, for example, context-adaptive binary arithmetic decoding processing. Here, for example, the syntax includes control data (flags and parameters) for controlling the decoding processing of the position information.

The tree synthesizing unit 2020 is configured to use, as input, the control data, which has been decoded by the geometry information decoding unit 2010, and an occupancy code indicating on which node in a tree described later a point cloud is present, and to generate tree information indicating in which region in a decoding target space points are present.

Note that the tree synthesizing unit 2020 may be configured to perform decoding processing of an occupancy code.

The present process can generate the tree information by recursively repeating processing of partitioning the decoding target space into cuboids, determining whether or not a point is present in each cuboid by referring to the occupancy code, dividing the cuboid in which the point is present into a plurality of cuboids, and referencing the occupancy code.

Here, inter prediction described later may be used in decoding the occupancy code.

In the present embodiment, it is possible to use a method called “octree” in which octree division is recursively carried out with the above-described cuboids always as cubes, and a method called “QtBt” in which quadtree division and binary tree division are carried out in addition to octree division. Whether or not “QtBt” is to be used is transmitted as the control data from the point cloud encoding device 100 side.

Alternatively, the tree synthesizing unit 2020 is configured to, when the control data designates use of predictive geometry coding, decode the coordinates of each point based on an arbitrary tree configuration determined by the point cloud encoding device 100.

The approximate-surface synthesizing unit 2030 is configured to generate approximate-surface information using the tree information generated by the tree synthesizing unit 2020, and decode a point cloud based on this approximate-surface information.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

More specifically, the approximate-surface synthesizing unit 2030 can generate the approximate-surface information and decode the point cloud by, for example, a method called “Trisoup”. A specific “Trisoup” processing example will be described later. In addition, when decoding a sparse point cloud acquired by Lidar or the like, the present processing can be omitted.

The geometry information reconfiguration unit 2040 is configured to reconfigure the geometry information (position information on the coordinate system assumed by the decoding processing) of each point of decoding target point cloud data based on the tree information generated by the tree synthesizing unit 2020 and the approximate-surface information generated by the approximate-surface synthesizing unit 2030.

The inverse coordinate transformation unit 2050 is configured to use, as input, the geometry information reconfigured by the geometry information reconfiguration unit 2040, to transform the coordinate system assumed by the decoding processing into a coordinate system of the output point cloud signal, and to output the position information.

The frame buffer 2120 is configured to use, as input, the geometry information reconfigured by the geometry information reconfiguration unit 2040 to store as a reference frame. The stored reference frame is read from the frame buffer 2130 and used as a reference frame in a case where the tree synthesizing unit 2020 performs inter prediction on temporally different frames.

Here, which time reference frame is used for each frame may be determined based on, for example, control data transmitted as a bit stream from the point cloud encoding device 100.

The attribute-information decoding unit 2060 is configured to use, as input, a bit stream (attribute-information bit stream) about the attribute information among the bit streams output from the point cloud encoding device 100, and to decode syntax.

The decoding processing is, for example, context-adaptive binary arithmetic decoding processing. Here, for example, the syntax includes control data (flags and parameters) for controlling the decoding processing of the attribute information.

Furthermore, the attribute-information decoding unit 2060 is configured to decode quantized residual information from the decoded syntax.

The inverse quantization unit 2070 is configured to perform an inverse quantization process based on the quantized residual information decoded by the attribute-information decoding unit 2060 and quantization parameters that are one of items of the control data decoded by the attribute-information decoding unit 2060, and to generate inverse-quantized residual information.

The inverse-quantized residual information is output to one of the RAHT unit 2080 and the LoD calculation unit 2090 according to a feature of the decoding target point cloud. To which one of the RAHT unit 2080 and the LoD calculation unit 2090 the inverse-quantized residual information is output is designated by the control data decoded by the attribute-information decoding unit 2060.

The RAHT unit 2080 is configured to use, as input, the inverse-quantized residual information generated by the inverse quantization unit 2070, and the geometry information generated by the geometry information reconfiguration unit 2040, and to decode the attribute information of each point by using a type of Haar transformation (that is inverse Haar transformation in the decoding processing) called Region Adaptive Hierarchical Transform (RAHT). As specific processes of the RAHT, for example, the method described in Non Patent Literature 1 (G-PCC codec description, ISO/IEC JTC1/SC29/WG7 N00271) can be used.

The LoD calculation unit 2090 is configured to use, as input, the geometry information generated by the geometry information reconfiguration unit 2040, and to generate a Level of Detail (LoD).

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Non Patent Literature 1 described above may be used.

The inverse lifting unit 2100 is configured to decode the attribute information of each point based on a hierarchical structure defined by the LoD using the LoD generated by the LoD calculation unit 2090 and the inverse-quantized residual information generated by the inverse quantization unit 2070. As specific processes of inverse lifting, for example, the method described in Non Patent Literature 1 described above can be used.

The inverse color transformation unit 2110 is configured to, when the attribute information of the decoding target is the color information, and color transformation has been carried out on the point cloud encoding device 100 side, perform an inverse color transformation process on the attribute information output from the RAHT unit 2080 or the inverse lifting unit 2100. Whether or not to perform the inverse color transformation process is determined according to the control data decoded by the attribute-information decoding unit 2060.

The point cloud decoding device 200 is configured to decode and output the attribute information of each point in the point cloud by the above processes.

### (Geometry Information Decoding Unit 2010)

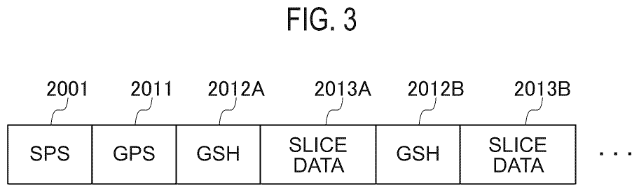

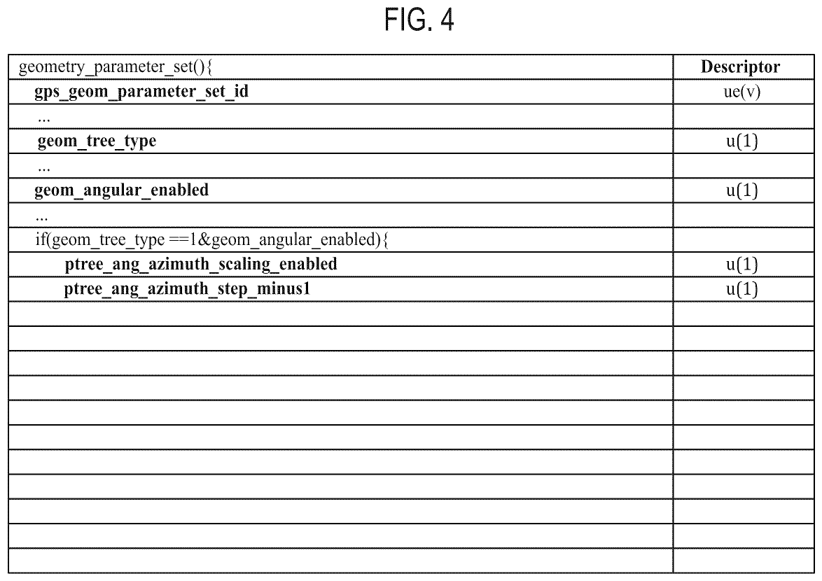

The control data decoded by the geometry information decoding unit 2010 will be described below with reference to FIGS. 3 and 4.

FIG. 3 illustrates an example of a configuration of encoded data (bit stream) received by the geometry information decoding unit 2010.

First, the bit stream may include a GPS 2011. The GPS 2011 is also called a geometry parameter set, and is a set of control data related to decoding of the geometry information. A specific example thereof will be described later. Each GPS 2011 includes at least GPS id information for identifying the individual GPSs 2011 in a case where there are the plurality of GPSs 2011.

Second, the bit stream may include a GSH 2012A/2012B. The GSH 2012A/2012B is also called a geometry slice header or a geometry data unit header, and is a set of control data corresponding to a slice to be described later. Hereinafter, a description will be given using the term “slice”, but the slice may be read as a data unit. A specific example thereof will be described later. The GSH 2012A/2012B includes at least GPS id information for designating the GPS 2011 associated with each of the GSH 2012A/2012B.

Third, the bit stream may include slice data 2013A/2013B in addition to the GSH 2012A/2012B. The slice data 2013A/2013B includes data obtained by encoding the geometry information. An example of the slice data 2013A/2013B includes the occupancy code to be described later.

As described above, the bit stream is configured such that each slice data 2013A/2013B is associated with the GSH 2012A/2012B and the GPS 2011 one by one.

As described above, since which GPS 2011 is referred to in the GSH 2012A/2012B is designated by the GPS id information, the GPS 2011 common to a plurality of items of slice data 2013A/2013B can be used.

In other words, the GPS 2011 does not necessarily need to be transmitted for each slice. For example, the bit stream may be configured such that the GPS 2011 is not encoded immediately before the GSH 2012B and the slice data 2013B as in FIG. 3.

Note that the configuration in FIG. 3 is merely an example. As long as each slice data 2013A/2013B is configured to be associated with the GSH 2012A/2012B and the GPS 2011, an element other than those described above may be added as a constituent element of the bit stream.

For example, as illustrated in FIG. 3, the bit stream may include a sequence parameter set (SPS) 2001. Similarly, the bit stream may have a configuration different from that in FIG. 3 at the time of transmission. Furthermore, the bit stream may be synthesized with a bit stream decoded by the attribute-information decoding unit 2060 described later and transmitted as a single bit stream.

FIG. 4 illustrates an example of a syntax configuration of the GPS 2011.

Note that syntax names described below are merely examples. The syntax names may vary as long as the functions of the syntaxes described below are similar.

The GPS 2011 may include GPS id information (gps_geom_parameter_set_id) for identifying each GPS 2011.

Note that a Descriptor column in FIG. 4 indicates how each syntax is encoded. ue(v) means an unsigned 0-order exponential-Golomb code, and u(1) means a 1-bit flag.

The GPS 2011 may include a flag (geom_tree_type) for controlling a tree type in the tree synthesizing unit 2020.

For example, when the value of geom_tree_type is “1”, it may be defined that Predictive geometry coding is used, and when the value of geom_tree_type is “0”, it may be defined that octree is used.

The GPS 2011 may include a flag (geom_angular_enabled) for controlling whether or not to perform processing in an Angular mode in the tree synthesizing unit 2020.

For example, when the value of geom_angular_enabled is “1”, it may be defined that Predictive geometry coding is performed in the Angular mode, and when the value of geom_angular_enabled is “0”, it may be defined that Predictive geometry coding is not performed in the Angular mode.

The GPS 2011 may include a flag (ptree_ang_azimuth_scaling_enabled) for controlling whether or not an adaptive azimuth angle quantization mode is activated in the Angular mode by the tree synthesizing unit 2020. The adaptive azimuth angle quantization mode is a mode for performing adaptive quantization of an azimuth angle according to a radius.

For example, when the value of ptree_ang_azimuth_scaling_enabled is “1”, it may be defined that the adaptive azimuth angle quantization according to the radius is performed, and when the value of ptree_ang_azimuth_scaling_enabled is “0”, it may be defined that the adaptive azimuth angle quantization according to the radius is not performed.

Furthermore, in the calculation (selection) of the predictor in the angular mode, the flag may be used as a flag for controlling whether to use the predictor list.

For example, when the value of ptree_azimuth_scaling_enabled is “1”, it may be defined that the predictor list is used in the calculation of such a predictor, and when the value of ptree_ang_azimuth_scaling_enabled is “0”, it may be defined that the predictor list is not used in the calculation of such a predictor.

The GPS 2011 may include a value (ptree_ang_azimuth_step_minus1) related to a rotation speed of a laser used to calculate a predicted value of an azimuth angle in the Angular mode by the tree synthesizing unit 2020.

### (Tree Synthesizing Unit 2020)

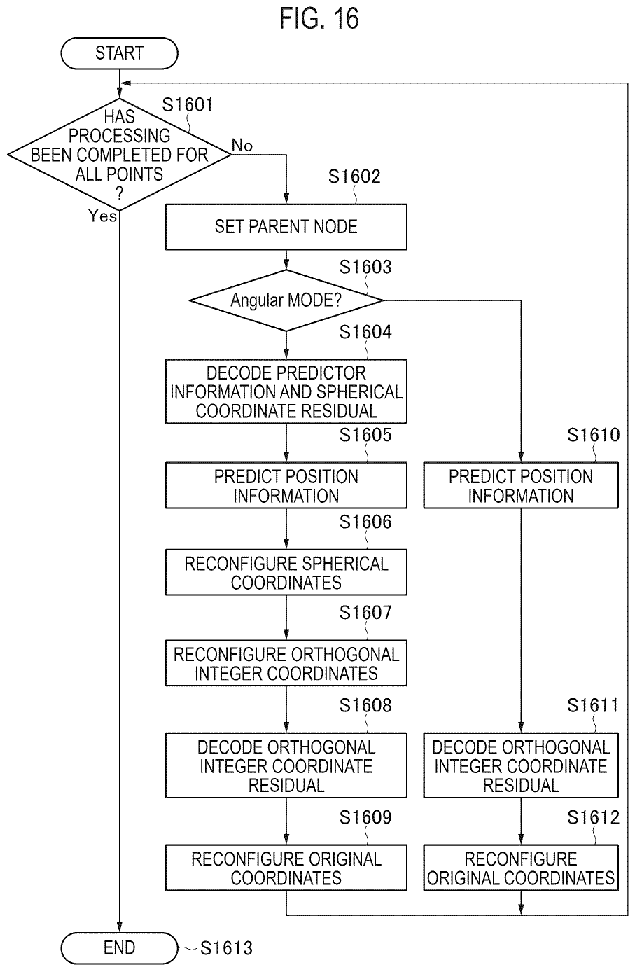

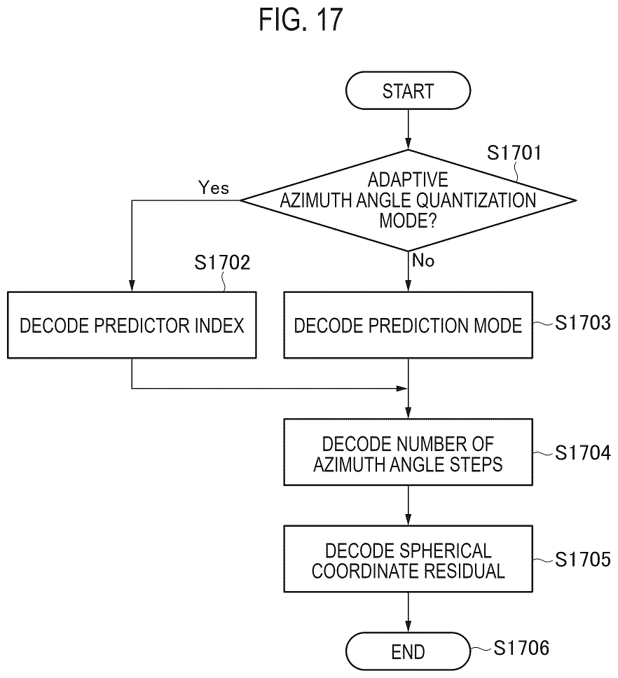

Hereinafter, an example of an operation of the tree synthesizing unit 2020 will be described with reference to FIGS. 16 and 17.

FIG. 16 is a flowchart illustrating an example of processing in the tree synthesizing unit 2020. Note that an example in a case where trees are synthesized using “Predictive geometry coding” will be described below.

The Predictive geometry coding is also called predictive tree. The Predictive geometry coding is a means for decoding a residual of position information predicted based on an arbitrary tree structure determined on a point cloud encoding device 100 side and position information of the point cloud data, and for decoding the position information of the point cloud data by adding both pieces of the position information.

As illustrated in FIG. 16, in step S1601, the tree synthesizing unit 2020 determines whether or not decoding of the position information of all the pieces of point cloud data included in the slice has been completed.

In the present processing, for example, information indicating the number of pieces of point cloud data included in the slice is transmitted to the GSH, and the number of pieces of point cloud data is compared with the number of pieces of already processed data, so that it is possible to determine whether or not the processing of all the points has been completed.

In a case where the decoding of the position information of all the pieces of point cloud data has been completed, the present operation proceeds to step S1613, and the processing is terminated. In a case where the decoding of the position information of all the pieces of point cloud data has not been completed, the present operation proceeds to step S1602.

In step S1602, the tree synthesizing unit 2020 sets a parent node of a decoding target node (processing target node) of the point cloud data.

For example, the tree synthesizing unit 2020 decodes the number of child nodes for each decoding target node, and stores the index of the decoding target node by the number of child nodes.

Then, in a case where the decoding target node is processed after a certain node, the tree synthesizing unit 2020 may refer to an array of the indexes of the node, acquire one index stored at the end of the array, and set a node of the acquired index as a parent node of the decoding target node.

After the setting of the parent node is completed, the present operation proceeds to step S1603.

In step S1603, the tree synthesizing unit 2020 determines whether or not to perform the processing in the Angular mode.

For example, the tree synthesizing unit 2020 can determine whether or not to perform the processing in the Angular mode by referring to the value of geom_angular_enabled described above.

In the case of performing the processing in the Angular mode, the present operation proceeds to step S1604, and in the case of not performing the processing in the Angular mode, the present operation proceeds to step S1610.

In step S1604, the tree synthesizing unit 2020 decodes predictor information and a spherical coordinate residual used in step S1605.

In step S1605, the tree synthesizing unit 2020 predicts the position information based on the predictor information decoded in step S504. Here, the predictor information is a predictor index or a prediction mode.

In such processing, the tree synthesizing unit 2020 first determines the type of the predictor to be used for prediction.

For example, the tree synthesizing unit 2020 may determine whether or not to perform the processing in the adaptive azimuth angle quantization mode based on the value of ptree_ang_azimuth_scaling_enabled, and determine the type of the predictor to be used based on the determination result.

For example, in the adaptive azimuth angle quantization mode, the tree synthesizing unit 2020 may select a predictor to be used based on the decoded prediction mode from among the plurality of predictors calculated using the tree structure.

Alternatively, in a case where the processing is performed in the adaptive azimuth angle quantization mode, the tree synthesizing unit 2020 may hold the position information of decoded nodes in the list as predictors, refer to a predictor allocated to a decoded predictor index from the list, and select the predictor as the type of predictor to be used.

Once the type of the predictor is determined, the tree synthesizing unit 2020 sets the predictor as the predicted value of the position information.

After the prediction of the position information is completed, the present operation proceeds to step S1606.

In step S1606, the tree synthesizing unit 2020 reconfigures spherical coordinates. In such processing, the tree synthesizing unit 2020 reconfigures the spherical coordinates by adding the decoded spherical coordinate residual and the predictor.

After the reconfiguration is completed, the present operation proceeds to step S1607.

In step S1607, the tree synthesizing unit 2020 reconfigures orthogonal integer coordinates. In such processing, the tree synthesizing unit 2020 can convert the spherical coordinates into the orthogonal integer coordinates based on the reconfigured spherical coordinates. As a specific method, for example, the method described in Non Patent Literature 1 can be implemented.

After the reconfiguration of the orthogonal integer coordinates is completed, the present operation proceeds to step S1608.

In step S1608, the tree synthesizing unit 2020 decodes an orthogonal integer coordinate residual.

After the decoding of the orthogonal integer coordinate residual is completed, the present operation proceeds to step S1609.

In step S1609, the tree synthesizing unit 2020 reconfigures the original coordinates. In such processing, the tree synthesizing unit 2020 reconfigures the original coordinates by adding the decoded orthogonal integer coordinate residual and the reconfigured orthogonal integer coordinates.

After the reconfiguration of the original coordinates is completed, the present operation returns to step S1601.

In step S1610, the tree synthesizing unit 2020 predicts the position information. Specifically, the tree synthesizing unit 2020 selects the predictor, and sets the predictor as the predicted value of the position information.

For example, the tree synthesizing unit 2020 may select, based on the decoded predictor mode, the predictor from among the plurality of predictors calculated based on the tree structure.

After the prediction of the position information is completed, the present operation proceeds to step S1611.

In step S1611, the tree synthesizing unit 2020 decodes the orthogonal integer coordinate residual.

After the decoding of the orthogonal integer coordinate residual is completed, the present operation proceeds to step S1612.

In step S1612, the tree synthesizing unit 2020 reconfigures the original coordinates. In such processing, the tree synthesizing unit 2020 reconfigures the original coordinates by adding the orthogonal integer coordinate residual decoded in step S1611 and the position information predicted in step S1610.

After the reconfiguration of the original coordinates is completed, the present operation returns to step S1601.

FIG. 17 is a flowchart illustrating an example of processing of decoding the predictor information and the spherical coordinate residual in step S1604.

As illustrated in FIG. 17, in step S1701, the tree synthesizing unit 2020 determines whether or not the adaptive azimuth angle quantization mode has been activated based on the value of ptree_ang_azimuth_scaling_enabled.

In a case where the adaptive azimuth angle quantization mode has been activated, the present operation proceeds to step S602. On the other hand, in a case where the adaptive azimuth angle quantization mode has not been activated, the present operation proceeds to step S1703.

In step S1702, the tree synthesizing unit 2020 decodes the predictor index. After the decoding of the predictor index is completed, the present operation proceeds to step S1704.

In step S1703, the tree synthesizing unit 2020 decodes the prediction mode. After the decoding of the prediction mode is completed, the present operation proceeds to step S1704.

In step S1704, the tree synthesizing unit 2020 decodes the number of azimuth angle steps. After the decoding of the number of azimuth angle steps is completed, the present operation proceeds to step S1705.

In step S1705, the tree synthesizing unit 2020 decodes the spherical coordinate residual. The tree synthesizing unit 2020 may perform such decoding using the method described in Non Patent Literature 2 (G-PCC 2nd Edition codec description, ISO/IEC JTC1/SC29/WG7 N00506). After the decoding is completed, the present operation proceeds to step S1706, and the processing ends.

### (Attribute-Information Decoding Unit 2060)

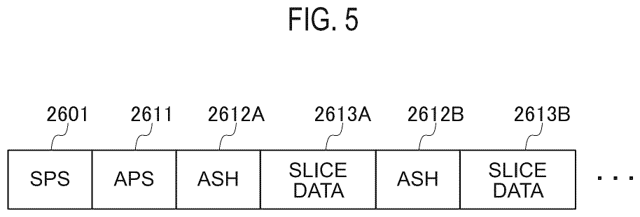

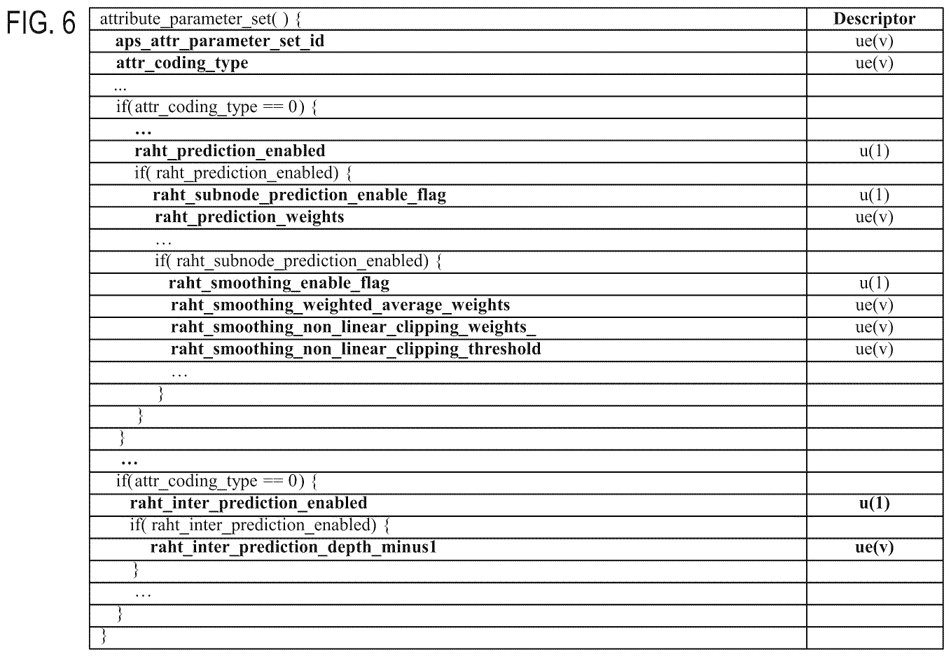

Control data decoded by the attribute-information decoding unit 2060 will be described below with reference to FIGS. 5 and 6.

FIG. 5 is an example of a configuration of encoded data (bit stream) received by the attribute-information decoding unit 2060, and FIG. 6 is an example of a syntax configuration of the APS 2611 illustrated in FIG. 5.

Note that syntax names described below are merely examples. The syntax names may vary as long as the functions of the syntaxes described below are similar.

The APS 2611 may include APS id information (aps_geom_parameter_set_id) for identifying each APS 2611.

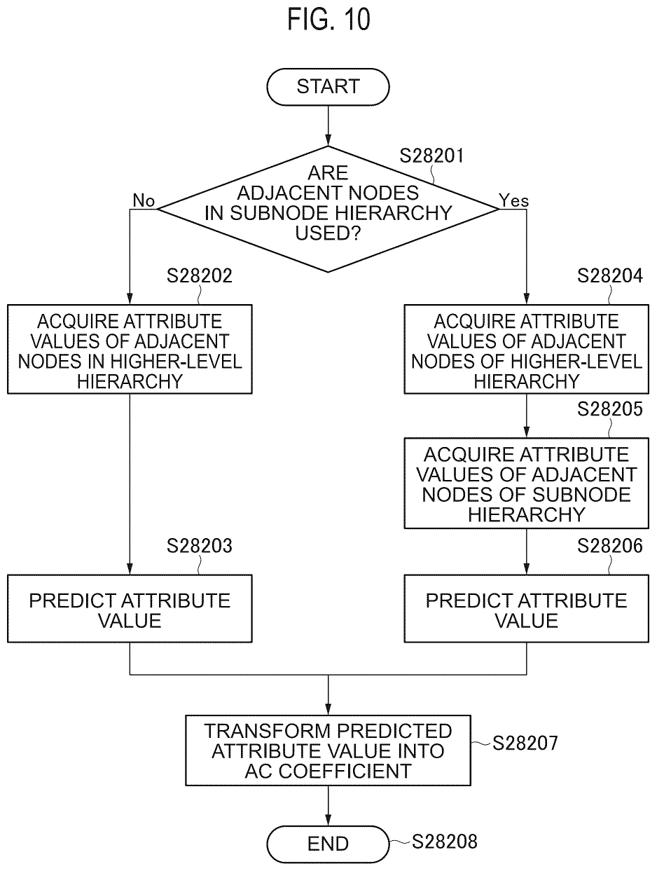

Note that the “Descriptor” field in FIG. 10 indicates how each syntax is encoded. ue(v) means an unsigned 0-order exponential-Golomb code, and u(1) means a 1-bit flag.

The APS 2611 may include a flag (attr_coding_type) for controlling which one of the RAHT unit 2080 and the LoD calculation unit 2090 the inverse quantization unit 2070 outputs inverse-quantized residual information to.

For example, when the value of attr_coding_type is “1”, it may be defined that the inverse-quantized residual information is output to the LoD calculation unit 2090, and when the value of attr_coding_type is “0”, it may be defined that the inverse-quantized residual information is output to the RAHT unit 2080.

The APS 2611 may include a flag (raht_prediction_enabled) for controlling whether the RAHT unit 2080 predicts attribute information.

For example, when the value of raht_prediction_enabled is “1”, it may be defined that attribute information is predicted, and when the value of raht_prediction_enabled is “0”, it may be defined that attribute information is not predicted.

The APS 2611 may include a flag (raht_subnode_prediction_enable_flag) for controlling whether the RAHT unit 2080 uses a subnode to predict attribute information.

For example, when the value of raht_subnode_prediction_enable_flag is “1”, it may be defined that a subnode is used to predict attribute information, and when the value of raht_subnode_prediction_enable_flag is “0”, it may be defined that a subnode is not used to predict attribute information.

The APS 2611 may include a weight parameter (raht_prediction_weights) when the RAHT unit 2080 performs intra prediction of attribute information.

For example, the value of raht_prediction_weights may be defined according to how the decoding target node is adjacent to the adjacent node used for intra prediction.

The APS 2611 may include a flag (raht_smoothing_enable_flag) for controlling whether the RAHT unit 2080 performs smoothing after performing intra prediction of attribute information.

For example, when the value of raht_smoothing_enable_flag is “1”, it may be defined that smoothing is performed after prediction of attribute information, and when the value of raht_smoothing_enable_flag is “0”, it may be defined that smoothing is not performed.

The APS 2611 may include a weight parameter (raht_smoothing_weighted_average_weights) for the RAHT unit 2080 to perform smoothing by weighted averaging after performing intra prediction of attribute information.

For example, up to eight such weight parameters may be defined according to how the decoding target node is adjacent to each subnode of the same parent node of the decoding target node.

The APS 2611 may include a weight parameter (raht_smoothing_clipping_weights) for the RAHT unit 2080 to perform smoothing by clipping after performing intra prediction of attribute information.

For example, up to eight such weight parameters may be defined according to how the decoding target node is adjacent to each subnode of the same parent node of the decoding target node.

The APS 2611 may include a threshold (raht_smoothing_clipping_threshold) for the RAHT unit 2080 to perform smoothing by clipping after performing intra prediction of attribute information.

The APS 2611 may include a flag (raht_inter_prediction_enabled) for controlling whether the RAHT unit 2080 performs inter prediction of attribute information.

For example, when the value of raht_inter_prediction_enabled is “1”, it may be defined that attribute information is predicted, and when the value of raht_inter_prediction_enabled is “0”, it may be defined that attribute information is not predicted.

The APS 2611 may include a value (raht_inter_prediction_depth_minus1) indicating a hierarchy in which the inter prediction of attribute information performed by the RAHT unit 2080 is enabled.

For example, when raht_inter_prediction_depth_minus1 is “N−1”, the inter prediction may be enabled in up to the higher N hierarchies of the octree structure.

### (RAHT Unit 2080)

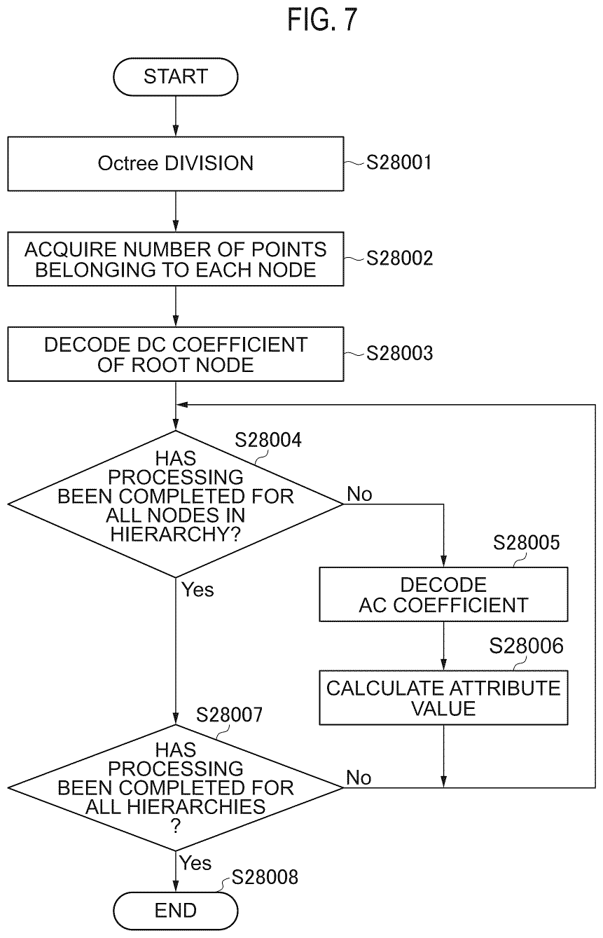

An example of processing of the RAHT unit 2080 will be described with reference to FIGS. 7 to 15.

FIG. 7 is a flowchart illustrating an example of processing of the RAHT unit 2080.

As illustrated in FIG. 7, in step S28001, the RAHT unit 2080 recursively divides a node into eight tree segments until the node has a predetermined size, using a technique called octree. After the division is completed, the present operation proceeds to step S28002.

In step S28002, for each node divided by the octree, the RAHT unit 2080 counts the total number of points belonging to the hierarchy lower than the node.

Specifically, the RAHT unit 2080 sequentially scans nodes in a certain hierarchy and records the number of points belonging to each node. Next, the RAHT unit 2080 adds up the numbers of points recorded in the child nodes of each of the nodes of the one level-higher hierarchy to calculate the number of points belonging to each node.

The RAHT unit 2080 repeats the above scanning in order from the lowest-level hierarchy to the highest-level hierarchy. The acquired total number of points is used as a weight for inverse transform of RAHT in step S28005 to be described later. After the calculation is completed, the present operation proceeds to step S28003.

In step S28003, the RAHT unit 2080 decodes the DC coefficient of the node belonging to the highest-level hierarchy of the octree. Alternatively, the RAHT unit 2080 may calculate the DC coefficient by predicting the DC coefficient using intra prediction, and decoding and adding prediction residuals of the DC coefficient.

After the decoding of the DC coefficient is completed, the RAHT unit 2080 calculates an attribute value Aᵣₒₒₜ of the root node by using the total number wᵣₒₒₜ of points belonging to the root node, which is acquired in step S28002, and the decoded DC coefficient DCᵣₒₒₜ according to the following formula.

$$[ Math . 1 ]$$

$${A}_{root} = D {C}_{root} \sqrt{{W}_{root}}$$

After the calculation is completed, the present operation proceeds to step S28004.

In step S28004, the RAHT unit 2080 determines whether the decoding of the attribute information has been completed for all the nodes included in the hierarchy.

When the decoding of the attribute information has not been completed for all the nodes included in the hierarchy, the present operation proceeds to step S28005, and when the decoding of the attribute information has been completed for all the nodes included in the hierarchy, the present operation proceeds to step S28007.

In step S28005, the RAHT unit 2080 decodes the AC coefficient. This will be described in detail later. When the decoding of the AC coefficient is completed, the present operation proceeds to step S28006.

In step S28006, the RAHT unit 2080 calculates an attribute value by using inverse transform of RAHT based on the counted total number of points belonging to the hierarchy lower than each node, the decoded AC coefficient, and the DC coefficient calculated from the node of the higher-level hierarchy by the method to be described later.

Here, the inverse transform of RAHT is performed in units of eight nodes (2×2×2) divided into eight tree segments by the octree.

Specifically, attribute values A₁, A₂, . . . , and Aₖ are obtained according to the following Formula (2) using the DC coefficients DC of the nodes holding k subnodes, the AC coefficients AC₁, AC₂, . . . , and A_{Ck-1}, and the total numbers w=w₁, w₂, . . . , and wₖ of points belonging to the hierarchy lower than each subnode.

$$[ Math . 2 ]$$

$$[ \begin{matrix}{A}_{1} / \sqrt{{w}_{1}} \\ ⋮ \\ {A}_{k} / \sqrt{{w}_{k}}\end{matrix} ] = {T ( w )}^{- 1} [ \begin{matrix}D C \\ A {C}_{1} \\ ⋮ \\ A {C}_{k - 1}\end{matrix} ] \qquad ( 1 )$$

Here, T(w)⁻¹ is a matrix used for inverse transform of RAHT, and can be generated, for example, by the method described in Non Patent Literature 1.

It is assumed that such transform processing is repeatedly performed in order from a node of a higher-level hierarchy to a node of a lower-level hierarchy, and

$$[ Math . 3 ]$$

$${A}_{1} / \sqrt{{w}_{1}} , {A}_{2} / \sqrt{{w}_{2}} , … , {A}_{k} / \sqrt{{w}_{k}}$$

which is used as a DC coefficient in the inverse transform of RAHT for each subnode. After the transform processing is completed, the present operation proceeds to step S28004.

In step S28007, the RAHT unit 2080 determines whether the decoding has been completed for all the nodes in all the hierarchies.

When the decoding has not been completed for all the nodes in all the hierarchies, the present operation moves the processing target hierarchy to the one level-lower hierarchy, and proceeds to step S28004. When the decoding has been completed for all the nodes in all the hierarchies, the present operation proceeds to step S28008, and the processing ends.

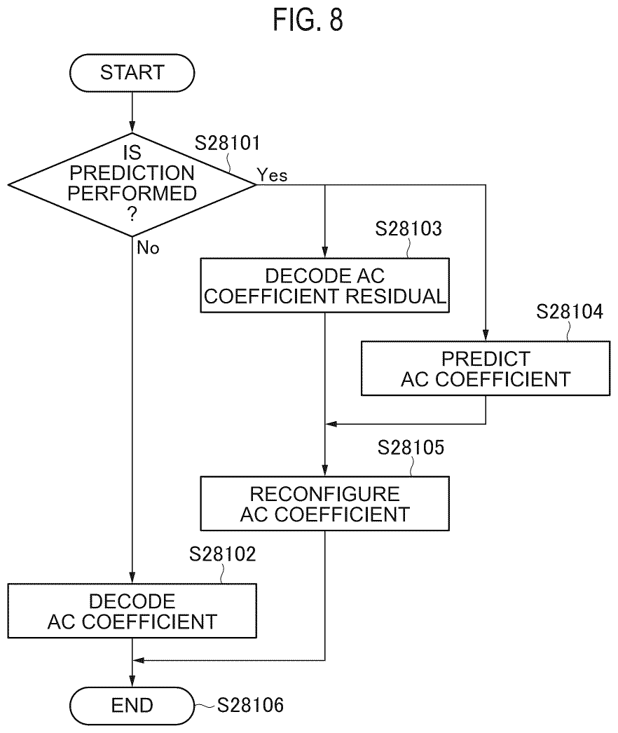

FIG. 8 is a flowchart illustrating an example of processing in step S28004.

As illustrated in FIG. 8, in step S28101, the RAHT unit 2080 determines whether to predict an AC coefficient. When making such a determination, the RAHT unit 2080 may refer to raht_prediction_enabled and use the value thereof.

The RAHT unit 2080 may decode the flag indicating whether to predict the AC coefficient in the current processing target node, and use the value of the flag.

Such a flag may be decoded for each node or may be decoded for each hierarchy. Such a flag may be decoded only when the value of raht_prediction_enabled is “1”, which is a value indicating that prediction is enabled. Such a flag may be included in the slice data.

As a result of the determination, when the AC coefficient is not predicted, the present operation proceeds to step S28102, and when the AC coefficient is predicted, the present operation proceeds to steps S28103 and S28104.

In step S28102, the RAHT unit 2080 decodes the AC coefficient. After the decoding is completed, the present operation proceeds to step S28106, and the processing ends.

In step S28103, the RAHT unit 2080 decodes the AC coefficient residual. After the decoding is completed, the present operation proceeds to step S28105.

In step S28104, the RAHT unit 2080 predicts an AC coefficient. For the prediction of the AC coefficient, inter prediction or intra prediction may be used.

The RAHT unit 2080 may first predict an attribute value and then calculate a predicted value of an AC coefficient by RAHT. This will be described in detail later. After the prediction of the AC coefficient is completed, the present operation proceeds to step S28105.

In step S28105, the RAHT unit 2080 adds the decoded AC coefficient residual and the predicted AC coefficient to reconfigure the AC coefficient. After the reconfiguration is completed, the present operation proceeds to step S28106, and the processing ends.

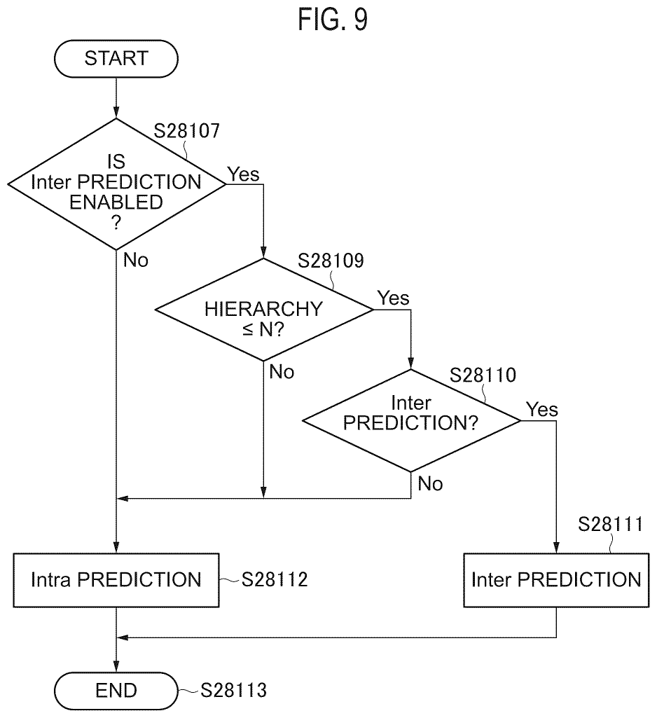

FIG. 9 is a flowchart illustrating an example of processing in step S28104.

As illustrated in FIG. 9, in step S28107, the RAHT unit 2080 determines whether inter prediction is enabled. For the determination, the RAHT unit 2080 may refer to raht_inter_prediction_enabled and use the value thereof. As a result of the determination, when inter prediction is enabled, the present operation proceeds to step S28109, and when inter prediction is disabled, the present operation proceeds to step S28112.

In step S28109, the RAHT unit 2080 determines whether the depth of the hierarchy including the processing target node is equal to or smaller than a threshold. The RAHT unit 2080 may refer to raht_inter_prediction_depth_minus1 as the threshold and use the value thereof.

As a result of the determination, when the depth is equal to or smaller than the threshold, the present operation proceeds to step S28110, and when the depth is larger than the threshold, the present operation proceeds to step S28112.

In step S28110, the RAHT unit 2080 determines whether to perform inter prediction on the AC coefficient of the processing target node.

For the determination, the RAHT unit 2080 may check whether inter prediction is executable, perform inter prediction when the inter prediction is executable, and not perform inter prediction when the inter prediction is not executable. This will be described in detail later.

For the determination, the RAHT unit 2080 may decode the flag indicating whether to perform inter prediction on the AC coefficient of the processing target node, and use the value of the flag. Such a flag may be decoded for each node or may be decoded for each hierarchy. Such a flag may be decoded only when it is determined that inter prediction is executable, and a determination may be made. Such a flag may be included in the slice data.

In step S28111, the RAHT unit 2080 performs inter prediction on the AC coefficient of the processing target node. This will be described in detail later.

In step S28112, the RAHT unit 2080 performs intra prediction on the AC coefficient of the processing target node. This will be described in detail later.

In step S28113, the processing in step S28104 ends. Note that the conditional branch in step S28109 may be omitted.

In the processing of inter prediction in step S28111, processing equivalent to the intra prediction in step S28112 may be performed together, and prediction may be performed by combining the results of the inter prediction and the intra prediction. This will be described in detail later.

FIG. 10 is a flowchart illustrating an example of processing of intra prediction in step S28112.

As illustrated in FIG. 10, in step S28201, the RAHT unit 2080 determines whether to perform intra prediction using adjacent nodes in the subnode hierarchy. For the determination, the RAHT unit 2080 may refer to raht_subnode_prediction_enable_flag and use the value thereof.

When adjacent nodes in the subnode hierarchy are not used, the RAHT unit 2080 performs intra prediction only using adjacent nodes in a higher-level hierarchy.

Here, the adjacent nodes in the higher-level hierarchy are 7 nodes, including 3 nodes face-adjacent to the decoding target node, 3 nodes edge-adjacent to the decoding target node, and the parent node itself, among a total of 19 nodes, including 6 nodes face-adjacent to the parent node of the decoding target node, 12 nodes edge-adjacent to the parent node of the decoding target node, and the parent node itself.

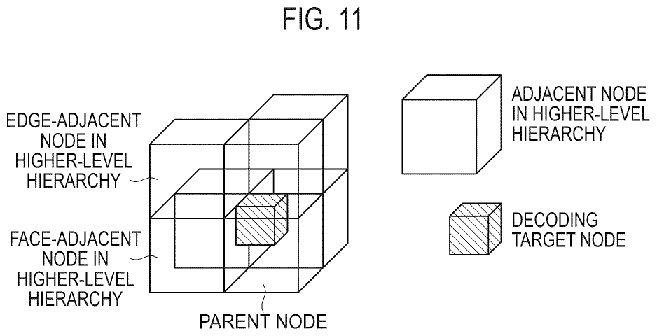

FIG. 11 is a diagram illustrating a relationship between a decoding target node and an adjacent node in a higher-level hierarchy.

When adjacent nodes in the subnode hierarchy are used, the RAHT unit 2080 performs intra prediction using adjacent nodes in the higher-level hierarchy together with the adjacent nodes in the subnode hierarchy.

Here, the adjacent nodes in the subnode hierarchy are decoded nodes face-adjacent or edge-adjacent to the decoding target node among the subnodes of the adjacent nodes in the higher-level hierarchy.

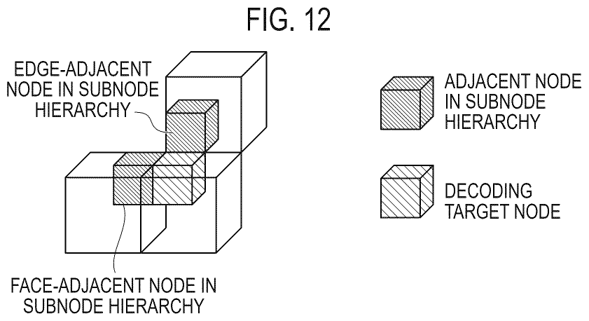

FIG. 12 is a diagram illustrating a relationship between a decoding target node and an adjacent node in a subnode hierarchy.

As a result of the determination, when intra prediction is performed without using adjacent nodes in the subnode hierarchy, the present operation proceeds to step S28202, and when intra prediction is performed using adjacent nodes in the subnode hierarchy, the present operation proceeds to step S28204.

In step S28202, the RAHT unit 2080 acquires attribute values of the adjacent nodes in the higher-level hierarchy. After the attribute values of the adjacent nodes in the higher-level hierarchy are acquired, the present operation proceeds to step S28203.

In step S28203, the RAHT unit 2080 predicts an attribute value of the decoding target node.

The RAHT unit 2080 may predict the attribute value attr according to the following formula, using the acquired attribute values attrᵢ of the k adjacent nodes in the higher-level hierarchy and the weights wᵢ according to the types of the adjacent nodes i.

$$[ Math . 4 ]$$

$$attr = \frac{{\sum }_{i} {w}_{i} {attr}_{i}}{{\sum }_{i} {w}_{i}}$$

Here, the RAHT unit 2080 may use a hard-coded value as the weight wᵢ depending on what type the adjacent nodes i are of among face-adjacent nodes in the higher-level hierarchy, edge-adjacent nodes in the higher-level hierarchy, and the parent node, or may refer to raht_prediction_weights and calculate the weight wᵢ from the value thereof.

After the prediction of the attribute value is completed, the present operation proceeds to step S28207.

In step S28204, the RAHT unit 2080 acquires attribute values of the adjacent nodes in the higher-level hierarchy.

Here, the targets for which attribute values are obtained are adjacent nodes in the higher-level hierarchy whose subnodes have not yet been decoded, or adjacent nodes in the higher-level hierarchy whose subnodes have been decoded but whose faces or edges are not adjacent to the decoding target node.

After the acquisition of the attribute values is completed, the present operation proceeds to step S28205.

In step S28205, the RAHT unit 2080 acquires attribute values of adjacent nodes in the subnode hierarchy. After the attribute values of the adjacent nodes in the subnode hierarchy are acquired, the present operation proceeds to step S28206.

In step S28206, the RAHT unit 2080 predicts an attribute value of the decoding target node.

The RAHT unit 2080 may predict the attribute value attr according to the following formula, using the acquired attribute values attrᵢ of the k adjacent nodes in the higher-level hierarchy and the adjacent nodes in the subnode hierarchy and the weights wᵢ according to the adjacent node type i.

$$[ Math . 5 ]$$

$$aatr = \frac{{\sum }_{i} {w}_{i} {attr}_{i}}{{\sum }_{i} {w}_{i}}$$

Here, the RAHT unit 2080 may use a hard-coded value as the weight wᵢ depending on what type the adjacent nodes i are of among face-adjacent nodes in the higher-level hierarchy, edge-adjacent nodes in the higher-level hierarchy, the parent node, face-adjacent nodes in the subnode hierarchy, and edge-adjacent nodes in subnode hierarchy, or may refer to raht_prediction_weights and calculate the weight wᵢ from the value thereof.

After the prediction of the attribute value is completed, the present operation proceeds to step S28207.

In step S28207, the RAHT unit 2080 transforms the predicted attribute value into an AC coefficient. The AC coefficient is generated by performing RAHT on the predicted attribute value. For example, the RAHT unit 2080 may use the method described in Non Patent Literature 1 as the transform method.

Although the example in which the RAHT unit 2080 uses the attribute value predicted in step S28206 directly for transformation into the AC coefficient in step S28207 has been described above, the RAHT unit 2080 may transform the predicted attribute value into the AC coefficient after smoothing the predicted attribute value.

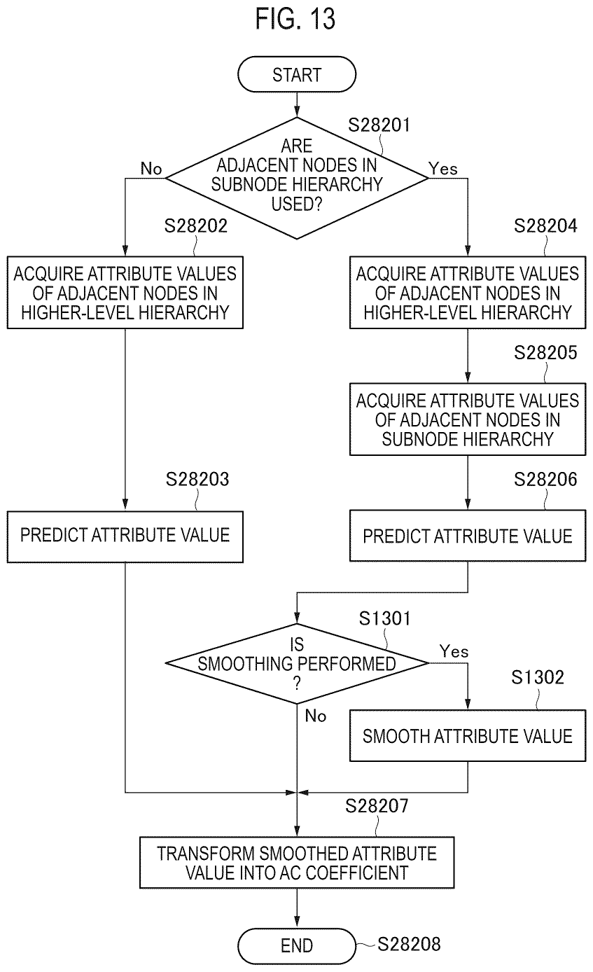

For example, as illustrated in FIG. 13, after predicting the attribute value, the RAHT unit 2080 may determine whether to perform smoothing in step S1301.

In such determination, the RAHT unit 2080 may refer to raht_smoothing_enable_flag and use the value thereof.

When smoothing is performed, the present operation proceeds to step S1302. When smoothing is not performed, the present operation proceeds to step S28207.

In step S1302, the RAHT unit 2080 may smooth the attribute value.

For example, the RAHT unit 2080 may obtain a smoothed attribute value Att_{rsmoothing} of the decoding target node by calculating a weighted average using the attribute values Attrᵢ and the weights ai predicted in the subnodes i in the same parent node as the decoding target node as follows.

$$[ Math . 6 ]$$

$${Attr}_{smoothing} = \frac{{\sum }_{i} {a}_{i} {Attr}_{i}}{{\sum }_{i} {a}_{i}}$$

Here, the subnodes i that are targets of the RAHT unit 2080 may be nodes that are face-adjacent to the decoding target node, or may be all subnodes in the same parent node.

Further, the RAHT unit 2080 may use a hard-coded value as the weight ai, or may refer to raht_smoothing_weighted_average_weights and use the value thereof.

Furthermore, the RAHT unit 2080 may obtain a smoothed attribute value Attr_{smoothing} of the decoding target node by performing clipping using the predicted value Attr₀ of the decoding target node itself, the attribute values Attrᵢ and the weights βᵢ predicted in the subnodes i other than the decoding target node among the subnodes in the same parent node as the decoding target node, and the thresholds Thᵣ as follows.

$$[ Math . 7 ]$$

$${Attr}_{smoothing} = {Attr}_{o} + \frac{{\sum }_{i} {β}_{i} Clip 3 ( {Attr}_{i} - {Attr}_{o} , - Thr , + Thr )}{{\sum }_{i} {β}_{i}}$$

Here, the clipping is processing in which a maximum value is output when the input value is larger than a predetermined maximum value, a minimum value is output when the input value is smaller than a predetermined minimum value, and the input value is used as it is as an output value otherwise.

The clipping function Clip3 is represented by:

$$[ Math . 8 ]$$

$$Clip 3 ( val , min , max ) = \{ \begin{matrix}min & if ( val < min ) \\ max & if ( val > max ) \\ val & Otherwise\end{matrix}$$

Here, the target subnodes i that are targets of the RAHT unit 2080 may be nodes that are face-adjacent to the decoding target node, may be nodes that are face-adjacent and edge-adjacent to the decoding target node, or may be all subnodes in the same parent node.

In addition, the RAHT unit 2080 may use a hard-coded value as the weight βᵢ, or may refer to raht_smoothing_clipping_weights and use the value thereof.

In addition, the RAHT unit 2080 may use a hard-coded value as the threshold Thᵣ, or may refer to raht_smoothing_clipping_threshold and use the value.

Although the example in which the RAHT unit 2080 decodes the AC coefficients of both chroma signals and luminance signals has been described above, the RAHT unit 2080 may skip decoding the AC coefficients of the chroma signals only for the lowest-level hierarchy of the octree.

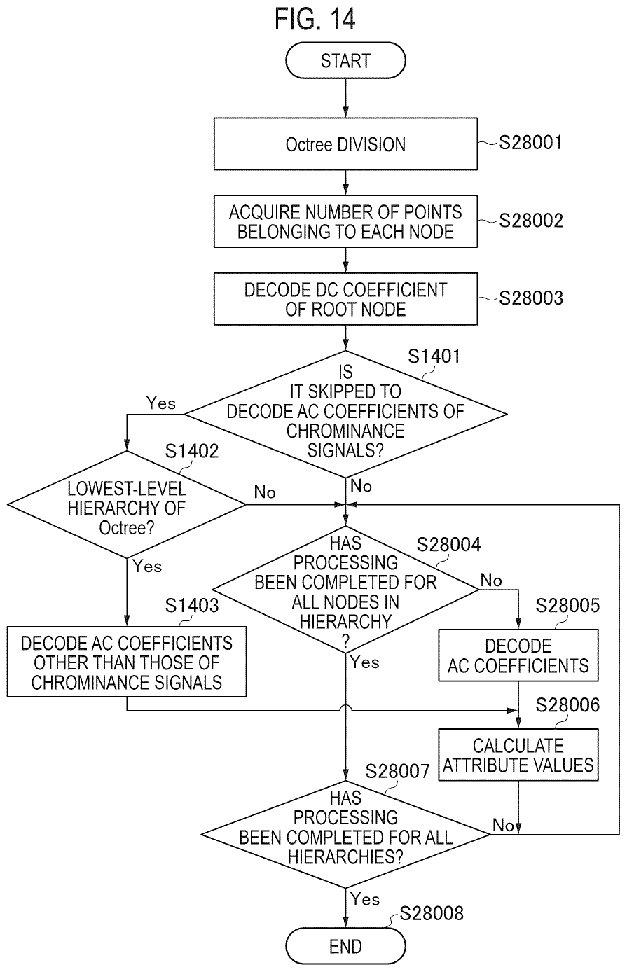

For example, as illustrated in FIG. 14, in step S1401, the RAHT unit 2080 may determine whether to skip decoding the AC coefficients of the chroma signals only for the lowest-level hierarchy of the octree.

When it is skipped, the present operation proceeds to step S1402. When it is not skipped, the present operation proceeds to step S28004.

In step S1402, the RAHT unit 2080 determines whether the decoding target node is in the lowest-level hierarchy of the octree.

When the decoding target node is in the lowest-level hierarchy, the present operation proceeds to step S1403. When the decoding target node is not in the lowest-level hierarchy, the present operation proceeds to step S28004.

In step S1403, the RAHT unit 2080 decodes AC coefficients other than those of the chroma signals.

The RAHT unit 2080 performs processing similar to that in step S28004 for decoding AC coefficients other than those of the chroma signals, and calculates attribute values in subsequent step S28005 with the AC coefficients of the chroma signals set to 0.

After the decoding of the AC coefficients other than those of the chroma signals is completed, the present operation proceeds to step S28006.

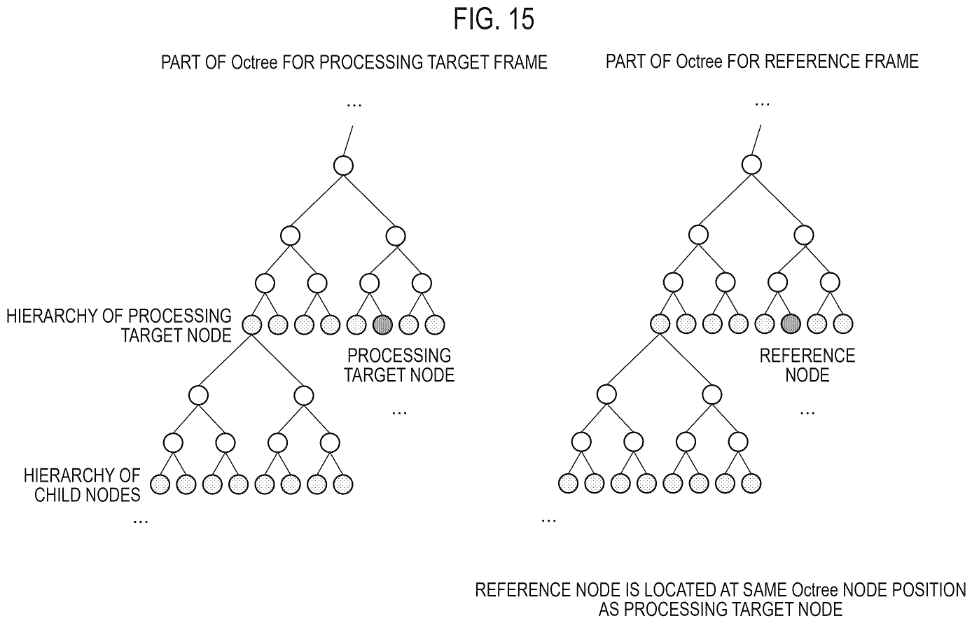

FIG. 15 is a diagram illustrating an example of inter prediction processing in step S28111.

The RAHT unit 2080 predicts AC coefficients of processing target nodes by using information on reference nodes, which are corresponding nodes in the reference frame. Here, the information on reference nodes may be attribute values or AC coefficients thereof. Furthermore, the reference frame refers to another decoded frame, and the information thereof may be included in a pre-frame buffer 2120.

The RAHT unit 2080 may apply the same octree structure to the reference frame as the processing target frame. In such a case, a node may be set at a position where there is no point. Such a node is referred to as an empty node. When the reference node is an empty node, the RAHT unit 2080 may disable inter prediction in step S28110.

The RAHT unit 2080 may apply an octree to the reference frame independently of the processing target frame, and set a different octree structure to the reference frame from the processing target frame. In such a case, there is a possibility that nodes do not necessarily exist at the same positions as those in the processing target frame. When no reference node is found at the position corresponding to the processing target node, the RAHT unit 2080 may disable inter prediction in step S28143.

When the reference node is an empty node or when no reference node is found, the RAHT unit 2080 may estimate and interpolate information on the reference node by using information on nodes at nearby positions in the reference frame.

For example, the RAHT unit 2080 may estimate and interpolate an average value of attribute values or AC coefficients of the adjacent nodes, the nearest nodes, or the k nearest nodes with respect to the reference node position as the attribute value or the AC coefficient of the reference node.

The RAHT unit 2080 may predict the AC coefficient of the processing target node, for example, from the attribute value of the reference node.

Specifically, the RAHT unit 2080 may obtain a predicted value Attr_{pred} of the attribute value of the processing target node by using a value Attrᵢₙₜₑᵣ of the decoded attribute value of the reference node, and obtain a predicted value AC_{pred} of the AC coefficient of the processing target node by applying RAHT to the predicted value Attr_{pred} of the attribute value of the processing target node.

$${Attr}_{pred} = {Attr}_{inter}$$

$$A {C}_{pred} = RAHT ( {Attr}_{pred} )$$

The RAHT unit 2080 may directly predict the AC coefficient of the processing target node, for example, from the AC coefficient of the reference node.

Specifically, the RAHT unit 2080 may calculate a value ACᵢₙₜₑᵣ of the AC coefficient of the reference node by using RAHT in the reference frame, and use the value as the predicted value AC_{pred} of the AC coefficient of the processing target node.

$$A {C}_{pred} = A {C}_{inter}$$

The RAHT unit 2080 may obtain the AC coefficient of the reference node by recording the AC coefficient of each node of the reference frame in the frame buffer 2120 and referring to the value in the frame buffer 2120. In such a case, in a case where the AC coefficient of the reference node does not exist in the frame buffer 2120, the RAHT unit 2080 may disable inter prediction in step S28110.

Note that the RAHT unit 2080 may multiply each of Attrinter and the ACinter by a with a scaling factor α.

$${Attr}_{pred} = α {Attr}_{inter} or$$

$$A {C}_{pred} = α A {C}_{inter}$$

The coefficient α may take any real number. The coefficient α may be decoded for each node or may be decoded for each hierarchy. The coefficient α may be included in the slice data.

For example, the coefficient α may be defined using the depth of the hierarchy as follows, and α may be decoded instead of the coefficient α.

$$α = 1 + {α}^{′} \cdot 2 - depth$$

For example, the integer β may be defined to be an integer ranging from integer a to integer b, and β may be decoded. The coefficient α may be calculated as a value obtained by adding integer c to the decoded β and then dividing the result by the integer c as follows.

$$α = ( β + c ) / c$$

The integer β may be decoded using an exponential-Golomb code.

Alternatively, the coefficient α may be derived by a decoder.

For example, the coefficient α may be calculated using an AC coefficient ACₚₐᵣₑₙₜ of the parent node of the decoding target node and an inter-predicted value ACₚₐᵣₑₙₜ inter obtained when the parent node is decoded as follows.

$$α = A {C}_{p a rent} / A {C}_{parent \_ inter}$$

For example, a may be calculated so as to minimize the cost using AC coefficients AC_{neighbor1}, AC_{neighbor2}, . . . , and AC_{neighborN} of N adjacent nodes of the decoding target node and inter-predicted values AC_{neighbor_inter1}, AC_{neighbor_inter2}, . . . , and AC_{neighbor_interN} obtained when the respective adjacent nodes are decoded.

The cost may be, for example, the sum of squared errors between the AC coefficients of the respective adjacent nodes and the predictors of the AC coefficients. For example, the adjacent nodes may be only face-adjacent nodes, or may be face-adjacent nodes and edge-adjacent nodes.

The RAHT unit 2080 may perform a similar operation by inter prediction of DC coefficients in step S28003.

$$D {C}_{pred} = α D {C}_{inter}$$

Here, the DC coefficient of the reference node is defined as DCᵢₙₜₑᵣ, and the predicted value of the DC coefficient of the root node is DC_{pred}.

In addition, the RAHT unit 2080 may calculate a predicted value of an attribute value or an AC coefficient by combining inter prediction and intra prediction.

For example, an example in which the RAHT unit 2080 obtains a predicted value of an attribute value will be described below.

$${Attr}_{pred} = {W}_{inter} \cdot {Attr}_{inter} + {W}_{intra} \cdot {Attr}_{intra}$$

Here, Attrᵢₙₜₑᵣ and Attrᵢₙₜᵣₐ are inter prediction and intra prediction of the attribute value, respectively. In addition, Wᵢₙₜₑᵣ and Wᵢₙₜᵣₐ are weights of inter prediction and intra prediction, respectively. Wᵢₙₜₑᵣ and Wᵢₙₜᵣₐ may be determined depending on the depth of the processing target hierarchy such that the deeper the hierarchy, the more importance is placed on intra prediction. For example,

$${W}_{inter} = 1 - depth / N$$

$${W}_{intra} = depth / N$$

N is a maximum value of the depth of the hierarchy in which inter prediction is enabled. The combination of inter prediction and intra prediction may be enabled only in a specific hierarchy. For example, the combination of inter prediction and intra prediction may be enabled only when M<depth<N. M may be any real number less than N, and may be decoded as header information such as APS.

### (Point Cloud Encoding Device 100)

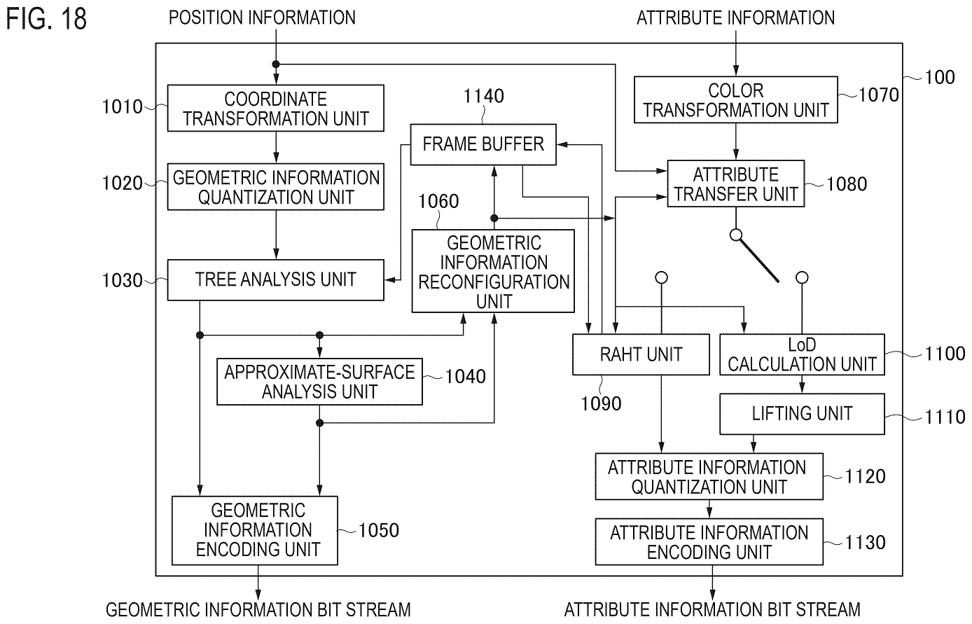

Hereinafter, the point cloud encoding device 100 according to the present embodiment will be described with reference to FIG. 18. FIG. 18 is a diagram illustrating an example of functional blocks of the point cloud encoding device 100 according to the present embodiment.

As illustrated in FIG. 18, the point cloud encoding device 100 includes a coordinate transformation unit 1010, a geometry information quantization unit 1020, a tree analysis unit 1030, an approximate-surface analysis unit 1040, a geometry information encoding unit 1050, a geometry information reconfiguration unit 1060, a color transformation unit 1070, an attribute transfer unit 1080, an RAHT unit 1090, an LoD calculation unit 1100, a lifting unit 1110, an attribute-information quantization unit 1120, an attribute-information encoding unit 1130, and a frame buffer 1140.

The coordinate transformation unit 1010 is configured to perform transformation processing from a three-dimensional coordinate system of an input point cloud to an arbitrary different coordinate system. In the coordinate transformation, for example, x, y, and z coordinates of the input point cloud may be transformed into arbitrary s, t, and u coordinates by rotating the input point cloud. Furthermore, as one of variations of the transformation, the coordinate system of the input point cloud may be used as it is.

The geometry information quantization unit 1020 is configured to perform quantization of position information of the input point cloud after the coordinate transformation and removal of points having overlapping coordinates. Note that, in a case where a quantization step size is 1, the position information of the input point cloud matches position information after quantization. That is, a case where the quantization step size is 1 is equivalent to a case where quantization is not performed.

The tree analysis unit 1030 is configured to generate an occupancy code indicating which node in an encoding target space a point is present, based on a tree structure to be described later, by using the position information of the point cloud after quantization as an input.

In the present processing, the tree analysis unit 1030 is configured to recursively partition the encoding target space into cuboids to generate the tree structure.

Here, in a case where a point is present in a certain cuboid, the tree structure can be generated by recursively performing processing of dividing the cuboid into a plurality of cuboids until the cuboid has a predetermined size. Each of such cuboids is referred to as a node. In addition, each cuboid generated by dividing the node is referred to as a child node, and the occupancy code is a code expressed by 0 or 1 as to whether or not a point is included in the child node.

As described above, the tree analysis unit 1030 is configured to generate the occupancy code while recursively dividing the node to a predetermined size.

In the present embodiment, it is possible to use a method called “octree” in which octree division is recursively carried out with the above-described cuboids always as cubes, and a method called “QtBt” in which quadtree division and binary tree division are carried out in addition to octree division.

Here, whether or not to use “QtBt” is transmitted to the point cloud decoding device 200 as control data.

Alternatively, it may be designated that Predictive geometry coding that uses any tree configuration is to be used. In such a case, the tree analysis unit 1030 determines the tree structure, and the determined tree structure is transmitted to the point cloud decoding device 200 as control data.

For example, the control data of the tree structure may be configured to be decoded by the procedure described in FIGS. 5 to 14.

The approximate-surface analysis unit 1040 is configured to generate approximate-surface information by using the tree information generated by the tree analysis unit 1030.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

Specifically, the approximate-surface analysis unit 1040 may be configured to generate the approximate-surface information by, for example, a method called “Trisoup”. In addition, when decoding a sparse point cloud acquired by Lidar or the like, the present processing can be omitted.

The geometry information encoding unit 1050 is configured to encode syntax such as the occupancy code generated by the tree analysis unit 1030 and the approximate-surface information generated by the approximate-surface analysis unit 1040 to generate a bit stream (geometry information bit stream). Here, the bit stream may include, for example, the syntax described with reference to FIG. 4.

The encoding processing is, for example, context-adaptive binary arithmetic encoding processing. Here, for example, the syntax includes control data (flags and parameters) for controlling the decoding processing of the position information.

The geometry information reconfiguration unit 1060 is configured to reconfigure geometry information (a coordinate system assumed by the encoding processing, that is, the position information after the coordinate transformation in the coordinate transformation unit 1010) of each point of the point cloud data to be encoded based on the tree information generated by the tree analysis unit 1030 and the approximate-surface information generated by the approximate-surface analysis unit 1040.

The frame buffer 1140 is configured to use, as input, the geometry information reconfigured by the geometry information reconfiguration unit 1060 and store the geometry information as a reference frame.

The stored reference frame is read from the frame buffer 1140 and used as a reference frame in a case where the tree analysis unit 1030 performs inter prediction of temporally different frames.

Here, which time reference frame is used for each frame may be determined based on, for example, a value of a cost function representing encoding efficiency, and information of the reference frame to be used may be transmitted to the point cloud decoding device 200 as the control data.

The color transformation unit 1070 is configured to perform color transformation when attribute information of the input is color information. The color transformation is not necessarily performed, and whether or not to perform the color transformation processing is encoded as a part of the control data and transmitted to the point cloud decoding device 200.

The attribute transfer unit 1080 is configured to correct an attribute value so as to minimize distortion of the attribute information based on the position information of the input point cloud, the position information of the point cloud after the reconfiguration in the geometry information reconfiguration unit 1060, and the attribute information after the color change in the color transformation unit 1070. As a specific correction method, for example, the method described in Non Patent Literature 1 can be applied.

The RAHT unit 1090 is configured to receive, as input, the attribute information transferred by the attribute transfer unit 1080 and the geometric information generated by the geometric information reconfiguration unit 1060, and to generate residual information for each point by using a type of Haar transform called region adaptive hierarchical transform (RAHT).

The information to be decoded includes DC components (DC coefficients) and AC components (AC coefficients) of the attribute information generated by using RAHT in encoding processing, and is transformed into the attribute information by using inverse transform of RAHT in decoding processing.

As specific RAHT processing, for example, the method described in Non Patent Literature 1 described above can be used.

The LoD calculation unit 1100 is configured to generate a level of detail (LoD) using the geometry information generated by the geometry information reconfiguration unit 1060 as an input.

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Non Patent Literature 1 described above may be used.

The lifting unit 1110 is configured to generate the residual information by lifting processing using the LoD generated by the LoD calculation unit 1100 and the attribute information after the attribute transfer in the attribute transfer unit 1080.

As specific processes of the lifting, for example, the method described in Non Patent Literature 1 described above may be used.

The attribute-information quantization unit 1120 is configured to quantize the residual information output from the RAHT unit 1090 or the lifting unit 1110. Here, a case where the quantization step size is 1 is equivalent to a case where quantization is not performed.

The attribute-information encoding unit 1130 is configured to perform encoding processing using the quantized residual information or the like output from the attribute-information quantization unit 1120 as syntax to generate a bit stream (attribute information bit stream) regarding the attribute information.

The encoding processing is, for example, context-adaptive binary arithmetic encoding processing. Here, for example, the syntax includes control data (flags and parameters) for controlling the decoding processing of the attribute information.

The point cloud encoding device 100 is configured to perform the encoding processing using the position information and the attribute information of each point in a point cloud as inputs and output the geometry information bit stream and the attribute information bit stream by the above processing.

### Modified Example 1

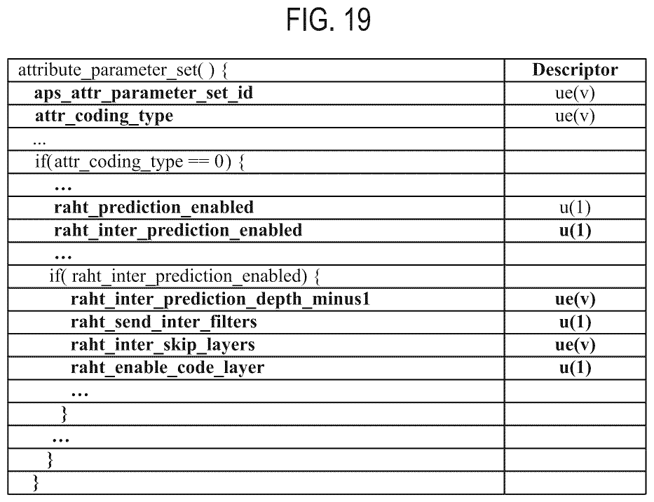

Hereinafter, modified example 1 of the above-described first embodiment will be described focusing on differences from the above-described first embodiment with reference to FIG. 19.

In the first embodiment described above, a case where the RAHT unit 2080 scales the inter prediction value ACᵢₙₜₑᵣ of the AC coefficient by the scaling factor different for each Octree hierarchy in step S28111 has been exemplified.

Here, scaling means that Attrᵢₙₜₑᵣ and ACᵢₙₜₑᵣ are multiplied by a scaling factor α, Attr_{pred}=αAttrᵢₙₜₑᵣ or AC_{pred}=αACᵢₙₜₑᵣ.

On the other hand, in modified example 1, a case where the RAHT unit 2080 performs scaling with different scaling factors for each Octree hierarchy and for each frequency index of the AC coefficient will be described.

Here, the frequency index of the AC coefficient is a number assigned to the AC coefficient generated using RAHT.

Furthermore, the scaling factor may be decoded as syntax included in the APS 2611 or the ASH 2612.

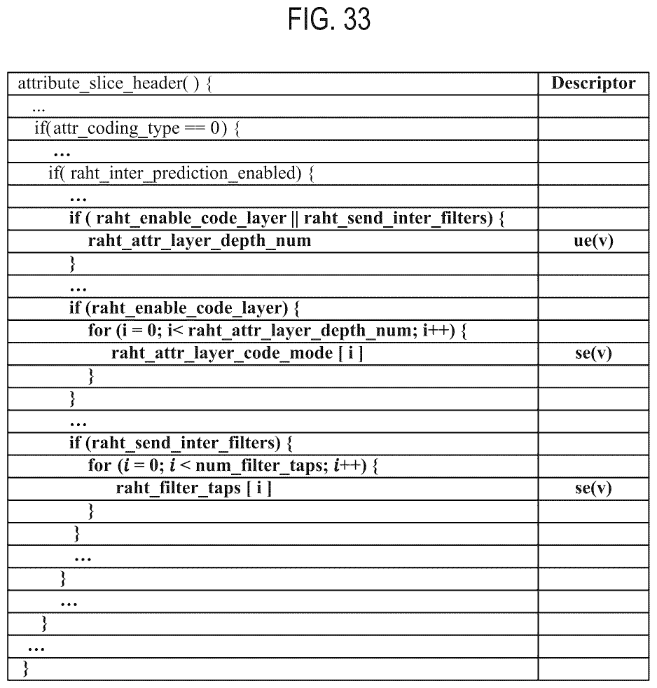

FIG. 19 and FIG. 33 illustrate examples of syntax configurations of the APS 2611 and the ASH 2612 in a case where scaling factors are transmitted in the ASH 2612. Note that, hereinafter, only a difference from the syntax configuration described in FIG. 6 will be described with respect to the syntax configuration illustrated in FIG. 33.

The APS 2611 may include a value (raht_send_inter_filters) indicating whether to transmit a scaling factor in inter prediction of attribute information.

For example, when raht_send_inter_filters is “1”, it may be defined that the scaling factor in the inter prediction of the attribute information is transmitted, and when raht_send_inter_filters is “0”, it may be defined that the scaling factor in the inter prediction of the attribute information is not transmitted.

For the inter prediction of the attribute information, the APS 2611 may include a value (raht_inter_skip_layers) indicating how many upper layers from the hierarchy of the root node of the Octree are excluded from scaling application of the inter prediction.

For example, when raht_inter_skip_layers is “3”, it may be defined that the inter prediction is not applied to the first to third layers.

The APS 2611 may include a value (raht_enable_code_layer) indicating whether to transmit an inter prediction applicability mode for each hierarchy. Alternatively, the APS 2611 may include raht_enable_code_layer when raht_prediction_enabled is “1” and raht inter prediction enabled is “1”.

For example, when raht_enable_code_layer is “1”, it may be defined that the inter prediction applicability mode for each hierarchy is transmitted, and when raht_enable_code_layer is “0”, it may be defined that the inter prediction applicability mode for each hierarchy is not transmitted.

When either raht_enable_code_layer or raht_send_inter_filters is “1”, the ASH 2612 may include a value (raht_attr_layer_depth_num) indicating the number of hierarchies of the frame.

Alternatively, for example, the ASH 2612 may include raht_attr_layer_depth_num when only raht_send_inter_filters is “1”.

Alternatively, raht attr layer depth num may be defined as a value obtained by subtracting 1 from the number of hierarchies of the frame, or may be used by adding 1 after decoding.

Alternatively, when raht attr layer depth num is “0”, raht_attr_layer_depth_num may be used as “0”, and when it is other than “0”, 1 may be subtracted and used after decoding.

When raht_enable_code_layer is “1”, the ASH 2612 may include as many inter prediction applicability modes (raht_attr_layer_code_mode) as the number of raht_attr_layer_depth_num for each hierarchy.

For example, in each hierarchy, when the inter prediction is applied, “1” may be defined, and when the inter prediction is not applied, “0” may be defined.

When raht_send_inter_filters is “1”, the ASH 2612 may include as many scaling factor values (raht_filter_taps) as the number of scaling factors (num_filter_taps) in inter prediction. num_filter_taps may be derived on the basis of a decoded syntax specifying a hierarchy to which inter prediction is applied.

Hereinafter, for the sake of simplicity, an example of a method of deriving num_filter_taps will be described using a case where there is one type of scaling factor for each hierarchy as an example.

For example, num_filter_taps may be derived on the basis of a value (raht_inter_skip_layers) indicating how many upper layers are excluded from application of inter prediction scaling, a value (raht_inter_prediction_depth_minus1) indicating the number of valid hierarchies of inter prediction, and the number of hierarchies of the frame (raht_attr_layer_depth_num).

Here, the number of valid hierarchies of the inter prediction is a numerical value indicating a threshold value for a hierarchy to which inter prediction is applied. For example, the number of valid hierarchies of the inter prediction may be a value obtained by adding 1 to raht_inter_prediction_depth_minus1, and when raht_inter_prediction_depth_minus1 is “N−1”, the number of valid hierarchies of the inter prediction may be defined as “N”.

Specifically, for example, num filter taps may be obtained by subtracting, from the number of valid hierarchies of inter prediction, a value indicating how many upper layers from the number of valid hierarchies of inter prediction are excluded from scaling application of the inter prediction in a case where the number of hierarchies of the frame is greater than the number of valid hierarchies of inter prediction, or may be obtained by subtracting, from the number of hierarchies of the frame, the value indicating how many upper layers from the number of hierarchies of the frame are excluded from scaling application of the inter prediction a case where the number of hierarchies of the frame is less than the number of valid hierarchies of inter prediction.

That is, num filter taps may be derived as follows:

$$[ Math . 9 ]$$

$$num\_filter \_taps = \{ \begin{matrix}raht\_prediction \_depth \_minus1 + 1 - raht\_inter \_skip \_layers & if raht\_prediction \_depth \_minus1 + 1 < raht\_attr \_layer \_depth \_num \\ raht\_attr \_layer \_depth \_num - raht\_inter \_skip \_layers & if raht\_prediction \_depth \_minus1 + 1 \geq raht\_attr \_layer \_depth \_num\end{matrix} .$$

Alternatively, for example, num filter taps may be derived on the basis of a value (raht_inter_skip_layers) indicating how many upper layers are excluded from application of scaling of inter prediction, a value (raht_inter_prediction_depth_minus1) indicating the number of valid hierarchies of inter prediction, a value (raht_attr_layer_depth_num) indicating the number of hierarchies of the frame, an0326d an inter prediction applicability mode (raht_attr_layer_code_mode) for each hierarchy.

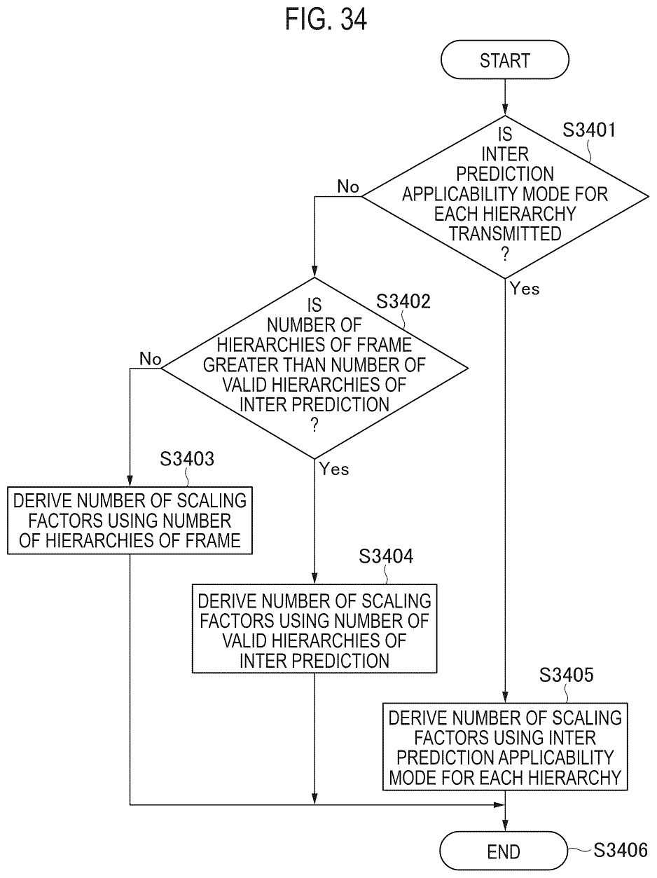

FIG. 34 is a flowchart illustrating an example of processing of deriving num filter taps on the basis of the value indicating how many upper layers are excluded from application of scaling of inter prediction, the value indicating the number of valid hierarchies of inter prediction, the number of hierarchies of the frame, and the inter prediction applicability mode for each hierarchy.

In step S3401, the attribute information decoding unit 2060 determines whether to transmit the inter prediction applicability mode for each hierarchy. For the determination, raht_enable_code_layer may be used.

In a case where it is determined that the inter prediction applicability mode for each hierarchy is to be transmitted, the present operation proceeds to step S3405, and in a case where it is determined that the inter prediction applicability mode for each hierarchy is not to be transmitted, the operation proceeds to step S3402.

In step S3402, the attribute information decoding unit 2060 determines whether the number of hierarchies of the frame is greater than the number of valid hierarchies of inter prediction. For the determination, for example, raht attr layer depth num and raht_inter_prediction_depth_minus1 described above may be used.

In a case where it is determined that the number of hierarchies of the frame is less than the number of valid hierarchies of inter prediction, the present operation proceeds to step S3403, and in a case where it is determined that the number of hierarchies of the frame is greater than the number of valid hierarchies of inter prediction, the operation proceeds to step S3404.

In step S3403, the attribute information decoding unit 2060 derives the number of scaling factors by using the number of hierarchies of the frame. Specifically, the attribute information decoding unit 2060 may obtain the number of scaling factors by subtracting, from the number of hierarchies of the frame, the value indicating how many upper layers are excluded from application of scaling of inter prediction. After deriving the number of scaling factors, the present operation proceeds to step S3406 and ends the processing.

In step S3404, the attribute information decoding unit 2060 derives the number of scaling factors by using the number of valid hierarchies of inter prediction. Specifically, the attribute information decoding unit 2060 may obtain the number of scaling factors by subtracting, from the number of valid hierarchies of inter prediction, the value indicating how many upper layers are excluded from application of scaling of inter prediction. After deriving the number of scaling factors, the present operation proceeds to step S3406 and ends the processing.

That is, the derivation of the number of scaling factors in steps S3402 to S3404 can be expressed by the following formula.

$$[ Math . 9 ]$$

$$num\_filter \_taps = \{ \begin{matrix}raht\_prediction \_depth \_minus1 + 1 - raht\_inter \_skip \_layers & if raht\_prediction \_depth \_minus1 + 1 < raht\_attr \_layer \_depth \_num \\ raht\_attr \_layer \_depth \_num - raht\_inter \_skip \_layers & if raht\_prediction \_depth \_minus1 + 1 \geq raht\_attr \_layer \_depth \_num\end{matrix} .$$

In step S3405, the attribute information decoding unit 2060 derives the number of scaling factors by using the inter prediction applicability mode for each hierarchy. Specifically, the attribute information decoding unit 2060 may count hierarchies to which inter prediction is applied on the basis of, for example, the inter prediction applicability mode for each hierarchy. However, the attribute information decoding unit 2060 may exclude a hierarchy to which scaling of inter prediction is not applied from counting on the basis of the value indicating how many upper layers are excluded from application of scaling of inter prediction. After deriving the number of scaling factors, the present operation proceeds to step S3406 and ends the processing.

Note that, although an example in which the above-described information is decoded by the APS 2611 has been described above, such information may be included in the ASH 2612 or may be included in the SPS 2601. That is, such information may be included in any header.

For example, when the above-described decoded raht_filter_taps is X, the RAHT unit 2080 may subtract X from 128, and use a value obtained by shifting the result to the right by 7 bits as the scaling factor α for inter prediction.

For example, when the value of raht_filter_taps is “0”, the value of the scaling factor α in inter prediction of attribute information may be defined as a value “1” obtained by subtracting 0 from 128 and shifting the result to the right by 7 bits.

For example, the RAHT unit 2080 may determine whether to apply inter prediction on the basis of syntax that specifies a hierarchy to which inter prediction is applied, and may scale the inter prediction value using the decoded raht filter taps when it is determined to apply inter prediction in the hierarchy. When it is determined that the inter prediction is not applied in the hierarchy, inter prediction may not be scaled.

Specifically, the RAHT unit 2080 may determine to scale inter prediction value when the depth of a hierarchy including a processing target node is equal to or less than the number of valid hierarchies of inter prediction, and the depth of the hierarchy including the processing target node is equal to or greater than the value indicating how many upper layers are excluded from application of scaling of inter prediction.

Here, the RAHT unit 2080 may refer to raht_inter_prediction_depth_minus1 and use the value with respect to the number of valid hierarchies of inter prediction.

In addition, the RAHT unit 2080 may refer to raht_inter_skip_layers and use the value with respect to the value indicating how many upper layers are excluded from application of scaling of inter prediction.

Alternatively, for example, the RAHT unit 2080 may determine to scale the inter prediction value when the depth of the hierarchy including the processing target node is equal to or less than the number of valid hierarchies of inter prediction, the depth of the hierarchy including the processing target node is equal to or greater than the value indicating how many upper layers are excluded from application of scaling of inter prediction, and it is determined that inter prediction is applied in the hierarchy including the processing target node.

Here, the RAHT unit 2080 may determine whether to apply inter prediction in the hierarchy including the processing target node with reference to raht_attr_layer_code_mode and on the basis of the value.

Although a case where scaling factor for each hierarchy is one has been described above, for example, even in a case where the scaling factor is transmitted for each frequency index idx of the AC coefficient, the number of scaling factors to be decoded can be derived by multiplying the number of scaling factors calculated above by the number of scaling factors for each hierarchy. The number of scaling factors may be, for example, seven.

Furthermore, for example, the scaling factor α_(depth_idx) different for each hierarchy and for each frequency index idx of the AC coefficient may refer to raht_filter_taps and use the value.

Alternatively, when raht_send_inter_filters is referred to and it is determined that raht_filter_taps is not transmitted, the scaling factor α_(depth_idx) may be any hardcoded value.

In addition, the RAHT unit 2080 may group the frequency indexes of the AC coefficients, allocate a group to each frequency index, and use the scaling factor of the corresponding group as the scaling factor of each frequency index.

In addition, the RAHT unit 2080 may be configured to derive other scaling factors on the basis of some of the decoded scaling factors.

For example, the scaling factors may be derived on the basis of a scaling factor of another hierarchy that has already been decoded.

That is, the RAHT unit 2080 may obtain the scaling factor α_(d2_idx) of each frequency index idx of the hierarchy d2 on the basis of the decoded scaling factor α_(d1_idx) of each frequency index idx of the hierarchy d1.

Alternatively, for example, the scaling factors may be derived on the basis of a scaling factor of another frequency index that has already been decoded.

That is, the RAHT unit 2080 may obtain the scaling factor α_(depth_i2) of the frequency index i2 of each hierarchy on the basis of the decoded scaling factor α_(depth_i1) of the frequency index i1 of each hierarchy.

Alternatively, for example, the scaling factors may be derived on the basis of scaling factors of another already decoded hierarchy and another already decoded frequency index.

That is, the RAHT unit 2080 may obtain the scaling factor α_(d2_i2) of the frequency index i2 of the hierarchy d2 on the basis of the decoded scaling factor α_(d1_i1) of the frequency index i1 of the hierarchy d1.

Further, after decoding the scaling factors, the RAHT unit 2080 may rearrange the order of the frequency indexes in an arbitrary order.

For example, the RAHT unit 2080 may rearrange the decoded scaling factors in the order of idx=3, 1, 5, 2, 6, 4, and 7 in the hierarchy depth.

### Modified Example 2

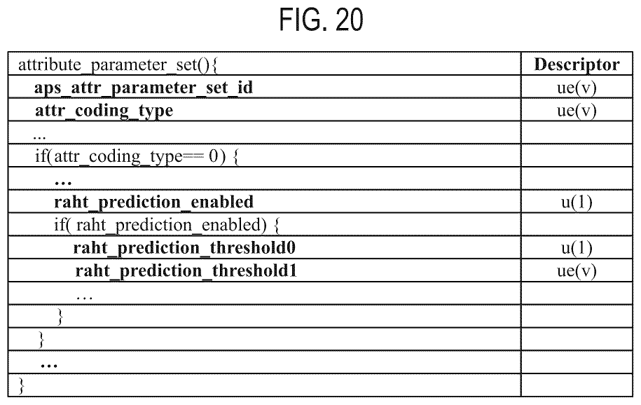

Hereinafter, modified example 2 of the above-described first embodiment will be described focusing on differences from the above-described first embodiment with reference to FIG. 20 to FIG. 25.

FIG. 20 illustrates an example of a syntax configuration of the APS 2611 in the present modified example. Only a difference from the syntax configuration described in FIG. 6 will be described.

The APS 2611 may include, as a condition for determining whether the RAHT unit 2080 performs prediction of attribute information, a value (raht_prediction_threshould0, raht_prediction_threshold1) indicating a threshold value of the number of adjacent nodes of a grandparent node and a parent node of a processing target node.

For example, when the number of adjacent nodes of the grandparent node of the processing target node is less than raht_prediction_threshould0, or when the number of adjacent nodes of the parent node of the processing target node is less than raht_prediction_threshould1, intra prediction of the attribute information is not performed, and otherwise, intra prediction of the attribute information may be performed.

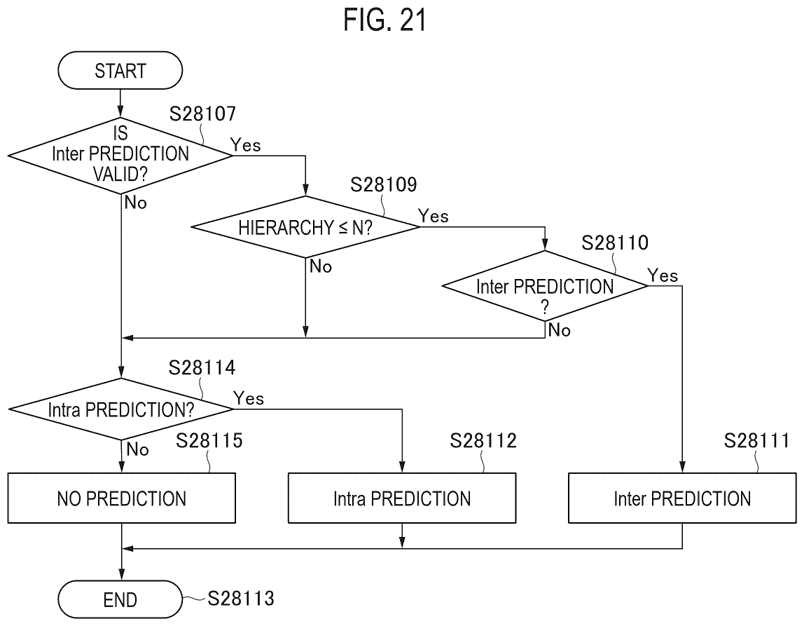

FIG. 21 is a flowchart illustrating an example of processing in step S28104. Note that, in the following, only a difference from the flowchart described with reference to FIG. 9 will be described, and portions not changed from FIG. 9 will be denoted by the same reference numerals, and description thereof will be omitted.

As illustrated in FIG. 21, in step S28114, it is determined whether to intra predict an AC coefficient of a processing target node of the RAHT unit 2080.

In such determination, the RAHT unit 2080 may check whether intra prediction is executable, perform intra prediction when intra prediction is executable, and perform no intra prediction when intra prediction is not executable.

For example, the RAHT unit 2080 may determine that intra prediction is executable when the numbers of adjacent nodes of the grandparent node and the parent node of the processing target node are equal to or greater than raht_prediction_threshould0 and raht_prediction_threshould1, respectively.

Alternatively, the RAHT unit 2080 may determine that intra prediction is executable when the number of adjacent nodes of the parent node of the processing target node is equal to or greater than raht_prediction_threshould1.

In such determination, the RAHT unit 2080 may decode a flag indicating whether the AC coefficient of the processing target node is to be intra-predicted, and use the value.

Such a flag may be decoded for each node or may be decoded for each hierarchy. Such a flag may be decoded only when it is determined that intra prediction can be performed by the above-described method, and the above-described determination may be performed. Such a flag may be included in slice data.

When intra prediction is executable, the present operation proceeds to step S28112, and when intra prediction is not executable, the present operation proceeds to step S28115.

In step S28115, the RAHT unit 2080 skips prediction of the AC coefficient of the processing target node. For example, the RAHT unit 2080 may not perform prediction and may input a prediction value of 0 to subsequent processing.

When step S28115 ends, the present operation proceeds to step S28113 and ends the processing of step S28104.

Note that the determination in step S28109 may be replaced with determination based on a syntax (flag or the like) included in a bit stream. Such syntax may be decoded for each layer of RAHT. Such syntax may be included in the APS 2611, the ASH 2612A/2612B, or the slice data 2613A/2613B.

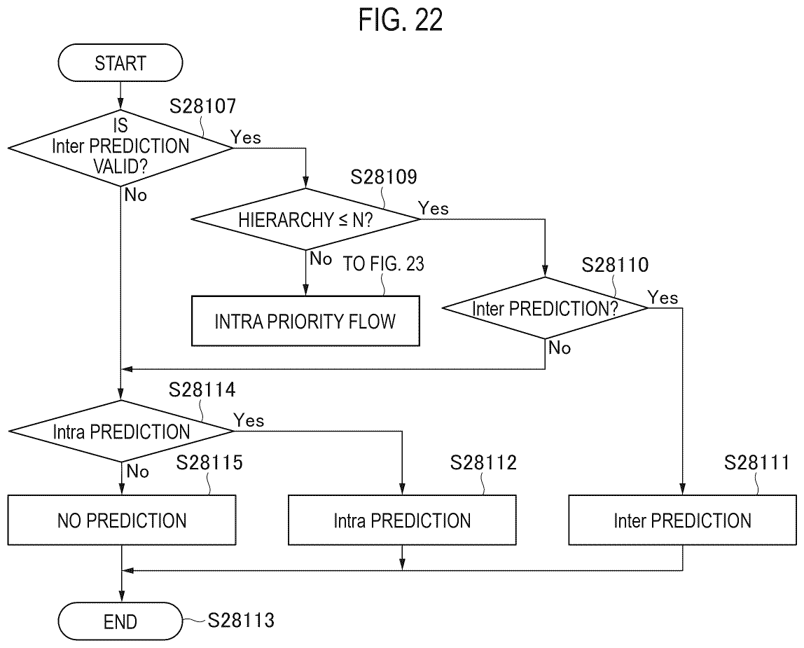

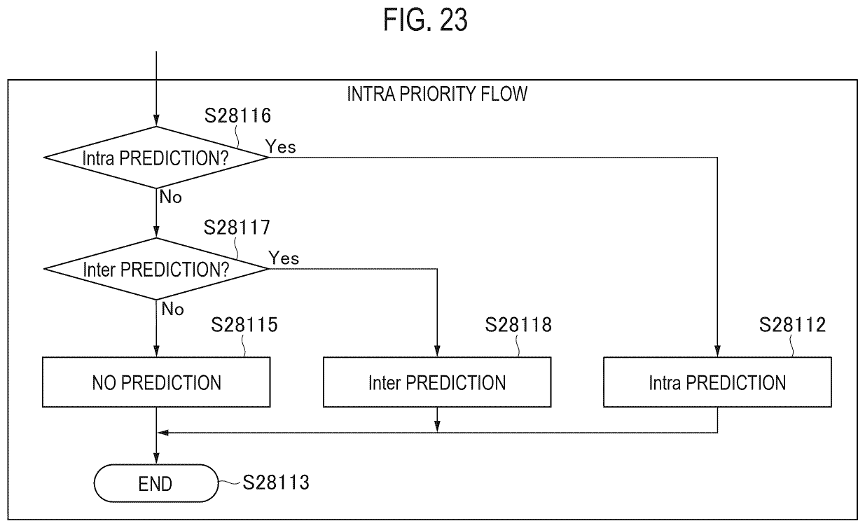

FIG. 22 and FIG. 23 are flowcharts illustrating an example of the processing of step S28104. Note that, hereinafter, only a difference from the flowchart described with reference to FIG. 21 will be described, and portions not changed from FIG. 21 will be denoted by the same reference numerals, and description thereof will be omitted.

As illustrated in FIG. 22, when the RAHT unit 2080 determines in step S28109 that the depth of the hierarchy including the processing target node is greater than the threshold value, the present operation proceeds to the intra priority flow of FIG. 23.

In the intra priority flow of FIG. 23, the present operation proceeds to step S28116.

In step S28116, the RAHT unit 2080 determines whether intra prediction is executable by a method similar to that in step S28114.

When the intra prediction is executable, the present operation proceeds to step S28112, and when the intra prediction is not executable, the present operation proceeds to step S28117.

In step S28117, the RAHT unit 2080 determines whether inter prediction is executable. Here, as in step S28110, the RAHT unit 2080 may decode a flag indicating the presence or absence of a reference node or whether to execute inter prediction, and perform determination based on the value. Such a flag may be decoded for each node in a certain hierarchy or higher, and the same flag as the parent node of the processing node may be used in a hierarchy lower than the certain hierarchy. A “certain hierarchy” may be specified by syntax included in a header of APS 2611, ASH 2612A/2612B, or the like, or may be specified by a preset fixed value.

When inter prediction is executable, the present operation proceeds to step S28118, and when the inter prediction is not executable, the present operation proceeds to step S28115.

In step S28118, the RAHT unit 2080 performs inter prediction of the AC coefficient of the processing target node.

Here, similarly to the method described with reference to FIG. 15, the RAHT unit 2080 may inter-predict the AC coefficient of the processing target node by using the AC coefficients or the attribute values of reference nodes or adjacent nodes of the reference nodes.

In addition, when the attribute values of the reference nodes or the adjacent nodes of the reference nodes are used, the RAHT unit 2080 may predict the AC coefficient of the processing target node by applying the RAHT using the weight of the processing target frame to the attribute values.

Further, the RAHT unit 2080 may perform inter prediction by using AC coefficients or attribute values of both the reference nodes and the adjacent nodes of the reference nodes.

For example, the RAHT unit 2080 may use the weighted average of the AC coefficients of the reference nodes and the adjacent nodes of the reference nodes as a predicted value of the AC coefficient of the processing target node.

In addition, the RAHT unit 2080 may use an AC coefficient obtained by applying the RAHT using the weight of the processing target frame to the weighted average of the attribute values of the reference nodes and the adjacent nodes of the reference nodes as a predicted value of the AC coefficient of the processing target node.

Here, with respect to the weights of the weighted average, the RAHT unit 2080 may set the weight of the reference nodes to be large and the weight of the adjacent nodes of the reference nodes to be small.

Further, with respect to the weights of the weighted average, the RAHT unit 2080 may set the weight of a surface adjacent node to be large and the weight of an edge adjacent node to be small, among the adjacent nodes of the reference nodes.

When the reference nodes or adjacent nodes of the reference nodes include an empty node, the RAHT unit 2080 may calculate the weighted average using values of nodes other than the empty node.

When such inter prediction is completed, the present operation proceeds to step S28113, and ends the processing of step S28104.

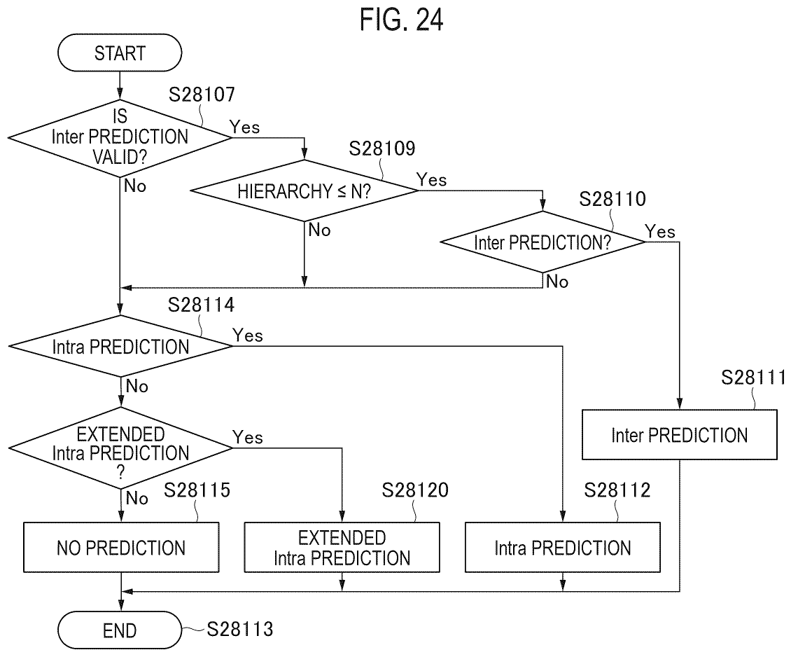

FIG. 24 is a flowchart illustrating an example of processing of step S28104. Note that, hereinafter, only a difference from the flowchart described with reference to FIG. 22 will be described, and portions not changed from FIG. 22 will be denoted by the same reference numerals, and description thereof will be omitted.

As illustrated in FIG. 24, when it is determined in step S28114 that intra prediction is not executable, the present operation proceeds to step S28119.

In step S28119, the RAHT unit 2080 determines whether to predict the AC coefficient of the processing target node by extended intra prediction. The extended intra prediction will be described later.

The RAHT unit 2080 may determine that extended intra prediction is executable, for example, when the number of adjacent nodes of the grandparent node and the parent node of the processing target node is equal to or greater than the threshold values. Here, the threshold value may be decoded as header information such as APS.

The RAHT unit 2080 may decode and determine a flag indicating whether to predict the AC coefficient of the processing target node by extended intra prediction. Such a flag may be included in slice data. Such a flag may be decoded for each node or may be decoded for each hierarchy. Such a flag may be decoded only when it is determined that extended intra prediction is executable by the method described above, and determination may be performed. Such a flag may be decoded for each node in a certain hierarchy or higher, and the same flag as the parent node of the processing node may be used in a hierarchy lower than the certain hierarchy. A “certain hierarchy” may be specified by syntax included in a header of APS 2611, ASH 2612A/2612B, or the like, or may be specified by a preset fixed value.

When it is determined that extended intra prediction is executable, the present operation proceeds to step S28120, and when it is determined that extended intra prediction is not executable, the present operation proceeds to step S28115.

In step S28120, the RAHT unit 2080 predicts the AC coefficient of the processing target node by extended intra prediction.

Here, in the extended intra prediction, an attribute value of a decoding target node is predicted with reference to the values of neighboring nodes that are not directly adjacent in addition to the values of adjacent nodes of the processing target node.

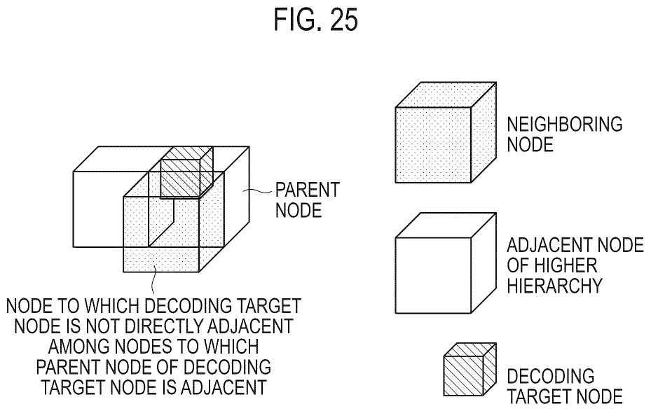

As illustrated in FIG. 25, a neighboring node used in extended intra prediction may be a node to which the decoding target node is not directly adjacent among nodes to which the parent node of the decoding target node is adjacent.

Prediction of the attribute value of the decoding target node is calculated by the weighted average of the attribute values of adjacent nodes of a hierarchy higher than the processing target node, adjacent nodes of a subnode hierarchy, and neighboring nodes, as in steps S28203 and S28206.

Conversion from a predicted value of an attribute value to a predicted value of an AC coefficient is performed by a method similar to step S28207.

### Modified Example 3

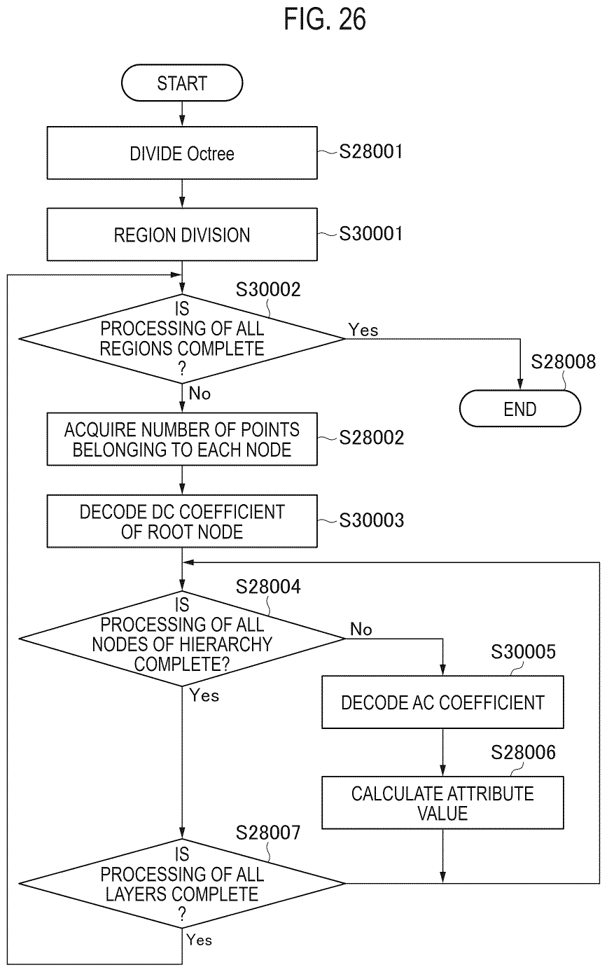

Hereinafter, modified example 3 of the above-described first embodiment will be described focusing on differences from the above-described first embodiment with reference to FIG. 26 to FIG. 34.

FIG. 26 is a diagram for describing a processing flow of RAHT in the present modified example 3. Note that, in the following, only differences from the portions described with reference to FIG. 7 will be described, and portions not changed from FIG. 7 will be denoted by the same reference numerals, and description thereof will be omitted.

In modified example 3, as illustrated in step S30001 in FIG. 7, the RAHT unit 2080 performs region division processing.

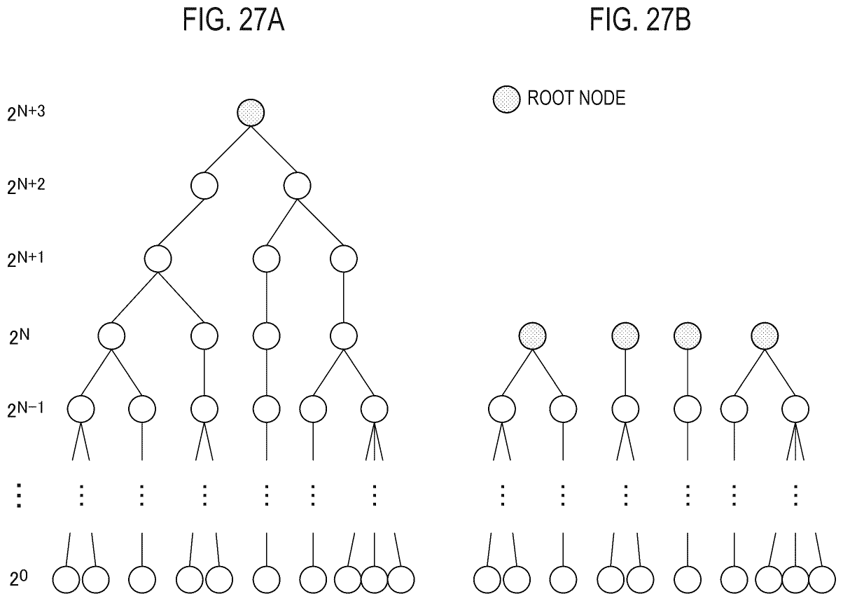

Hereinafter, an example of such region division processing will be described with reference to FIG. 27.

FIG. 27A is an example of an Octree constructed in step S28001.

In the flow of FIG. 7, the RAHT unit 2080 performs subsequent processing on the Octree in FIG. 27A.

On the other hand, in the present modified example 3, as illustrated in FIG. 27B, the RAHT unit 2080 divides the Octree described above at predetermined hierarchies (hierarchies having a node size of 2N in the example of FIG. 27B).

Hereinafter, a cluster of nodes connected to one root node is referred to as a “tree”.

It can be said that processing in step S30001 is processing of dividing one tree as illustrated in FIG. 27A into a plurality of trees. Note that dividing a tree for each node having a predetermined size can also be said to be processing of dividing a space to be decoded into regions corresponding to respective root nodes.

In modified example 3, the RAHT unit 2080 performs RAHT processing on the plurality of trees divided as described above.

Here, in the example in FIG. 26, the RAHT unit 2080 first performs Octree processing in step S28001, and then performs region division processing in step S30001, but this order may be changed, and region division processing in step S30001 may be performed first, and then the Octree processing in step S28001 may be performed for each region.

When the region division processing in step S30001 is executed first, it can be realized by classifying each point for each point belonging to the same root node from coordinate information of each point to be decoded and the predetermined node size.

Specifically, for example, the RAHT unit 2080 may first sort points to be decoded in order of Morton codes, and then divide the points into regions for each root node.

When the Octree processing is performed in the order of Morton codes, the points to be decoded are sorted in the order of Morton codes, and thus points belonging to the same root node appear consecutively, which facilitates region division.

Furthermore, the predetermined node size may be decoded as syntax included in the APS 2611 or the ASH 2612.

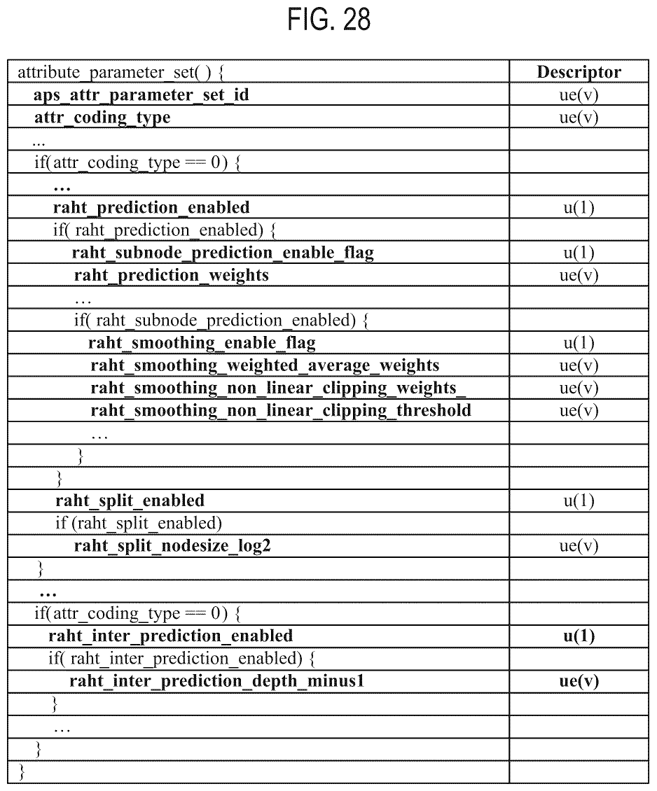

FIG. 28 illustrates an example of a syntax table in a case where the information is transmitted by the APS 2611.

The attribute information decoding unit 2060 may decode a flag (raht split enabled) for controlling whether to execute the region division processing. When the value of the flag is “1”, it may be specified that the RAHT unit 2080 executes division processing and performs the processing in the flow of FIG. 26. On the other hand, when the value of the flag is “0”, it may be specified that the RAHT unit 2080 does not perform division processing, and performs the processing in the flow of FIG. 7, for example.

In addition, when the flag for controlling whether to execute region division processing indicates “region division”, the attribute information decoding unit 2060 may decode a syntax (raht_split_nodesize_log2) that specifies a root node size at the time of region division.

When the value that can be taken as the root node size is only a power of 2, the attribute information decoding unit 2060 may decode, as such syntax, a value converted into a logarithm having a base of 2 with respect to the root node size.

In addition, when the minimum value of the root node size is specified, the attribute information decoding unit 2060 may decode a value obtained by subtracting the minimum value in advance as the syntax.

For example, when the minimum value of the root node size is 4 (=22), the attribute information decoding unit 2060 may calculate a final root node size by first adding 2 to the value decoded as raht_split_nodesize_log2 and then converting the value into a power of 2.

Further, the attribute information decoding unit 2060 may decode at which hierarchy (level) of the Octree the region is to be divided, instead of the root node size.

For example, the attribute information decoding unit 2060 may decode a value indicating at which level the tree is to be divided in a case where the densest hierarchy in the Octree is defined as level 0, and levels 1 and 2 are defined as levels become more sparse by one level.

Note that, although an example in which the above-described information is decoded by the APS 2611 has been described above, such information may be included in the ASH 2612 or may be included in the SPS 2601. That is, such information may be included in any header.

After the above-described region division processing is executed, the present operation proceeds to step S30002.

In step S30002, the RAHT unit 2080 checks whether the processing has been completed for all the regions (trees). When such processing is completed, the present operation proceeds to step S28008 and ends the processing. On the other hand, when such processing is not completed, the present operation proceeds to step S28002.

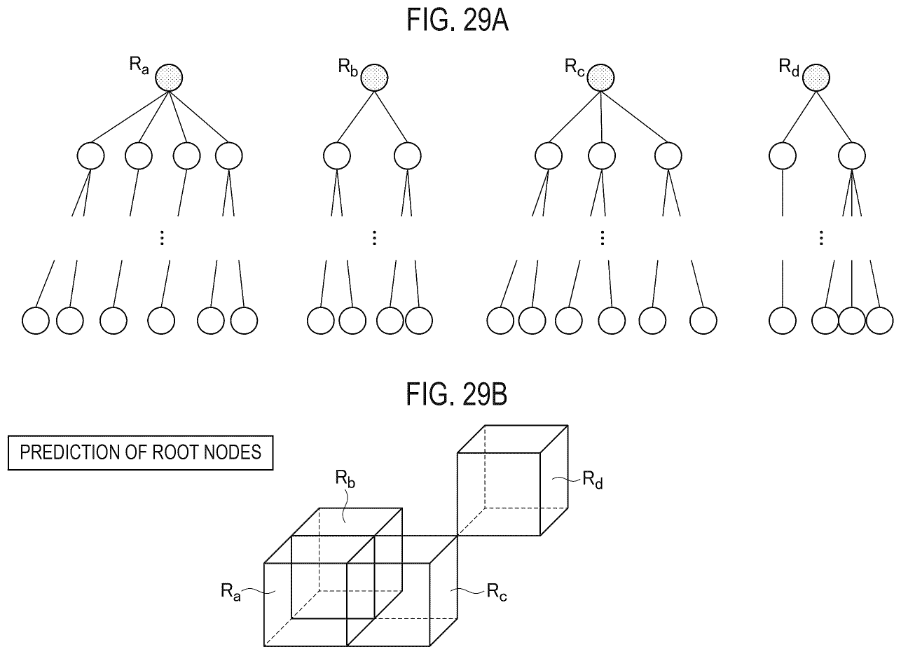

Next, a difference between processing of decoding DC coefficients in step S30003 and step S28003 will be described with reference to FIG. 29.

In the example of step S28003, there is only one root node, but in the present modified example 3, there are a plurality of root nodes and DC coefficients corresponding thereto as described above.

FIG. 29A illustrates an example in a case where there are four root nodes (Rₐ, R_{b}, R_{c}, R_{d}). Here, the decoding order is as follows: the tree of Rₐ→the tree of R_{b}→the tree of R_{c}→the tree of R_{d}.

For example, the DC coefficients of the root nodes may be decoded independently of each other. With such a configuration, processing of decoding the DC coefficients of the respective root nodes can be executed in parallel, and the processing time can be reduced.

Furthermore, for example, the RAHT unit 2080 may generate a predicted value of the DC coefficient of a root node of a tree to be decoded by using the DC coefficient of the root node that has already been decoded, and sum the predicted value and the decoded DC coefficient value (residual of the DC coefficient) to decode the DC coefficient of the root node of the tree to be decoded.

Specifically, for example, the RAHT unit 2080 may use the DC coefficient decoded immediately before in the decoding order as the above-described predicted value.

In the example of FIG. 29A, the RAHT unit 2080 uses the DC coefficient of the root node of the tree of Rₐ to predict the DC coefficient of the root node of the tree of R_{b}, and uses the DC coefficient of the root node of the tree of R_{b} to predict the DC coefficient of the root node of the tree of R_{c}.

Furthermore, for example, the RAHT unit 2080 may perform intra prediction as described with reference to FIG. 10 using the DC coefficient of the root node that has already been decoded.

For example, as shown in FIG. 29B, the root nodes (Rₐ, R_{b}, R_{c}, R_{d}) may be spatially adjacent, and thus in this case the intra prediction described in FIG. 10 can be performed.

Since there is no node at a higher level than the root node, the predicted value generation processing in step S28206 is executed only from the attribute value of the subnode hierarchy in step S28205 in FIG. 10.

With such a configuration, the code amount of the DC coefficients can be reduced.

Further, the RAHT unit 2080 may perform inter prediction by using DC coefficients of other frames that have already been decoded.

Next, the AC coefficient decoding processing in step S30005 will be described.

The processing in step S30005 is basically the same as the processing described in step S28005 and FIG. 10. The difference is a search range when the attribute values of the adjacent nodes or the subnodes described in step S28202, step S28204, and step S28205 of FIG. 10 are acquired.

For example, when acquiring the attribute values of the adjacent nodes or the subnodes described in step S28202, step S28204, and step S28205 of FIG. 10, the RAHT unit 2080 may set only the nodes belonging to the same root node as the search range.

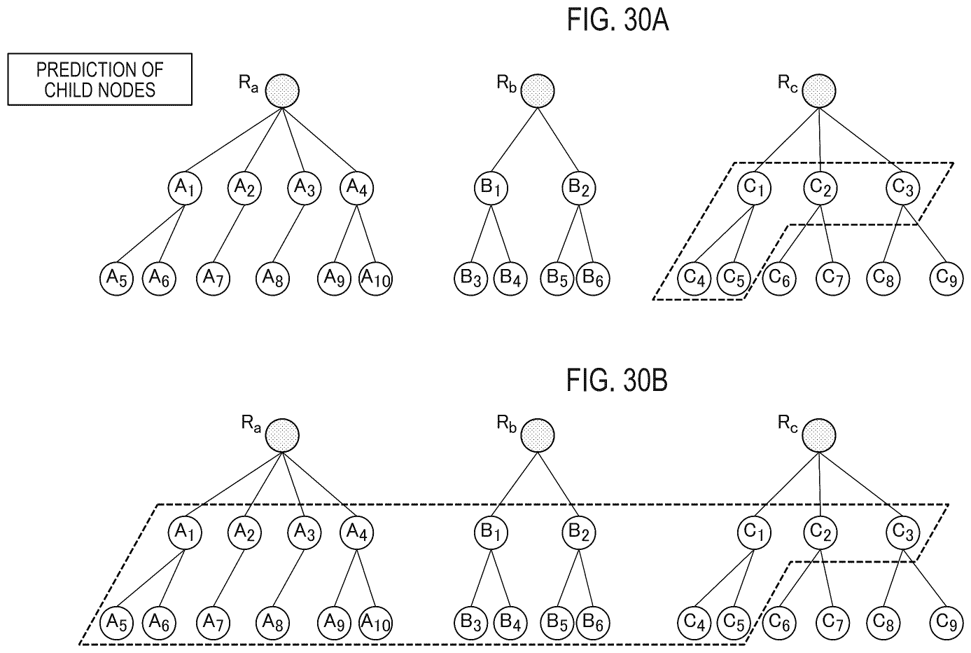

For example, when performing intra prediction of the AC coefficient of the node C6 in FIG. 30A, the RAHT unit 2080 may set a region surrounded by a dotted line as the search range.

Specifically, the RAHT unit 2080 may set the nodes C1 to C3 as the search range in steps S28202 and S28204, and may set the nodes C4 and C5 as the search range in step S28205.

With such a configuration, the AC coefficients can be decoded independently for each tree, and thus parallel processing can be performed in units of trees.

Furthermore, for example, when acquiring the attribute values of the adjacent nodes or the subnodes described in step S28202, step S28204, and step S28205 in FIG. 10, the RAHT unit 2080 may include all the decoded nodes including nodes belonging to other root nodes in the search range.

For example, when performing intra prediction of the AC coefficient of the node C6 in FIG. 30B, the RAHT unit 2080 may set a region surrounded by a dotted line as the search range.

Specifically, the RAHT unit 2080 may set the nodes A1 to A3, B1, B2, and C1 to C3 as the search range in steps S28202 and S28204, and may set the nodes A4 to A10, B3 to B6, C4, and C5 as the search range in step S28205.

With such a configuration, as compared with the configuration of FIG. 30A, a large number of nodes can be used for prediction, and thus prediction accuracy is improved and the code amount of the AC coefficients can be reduced.

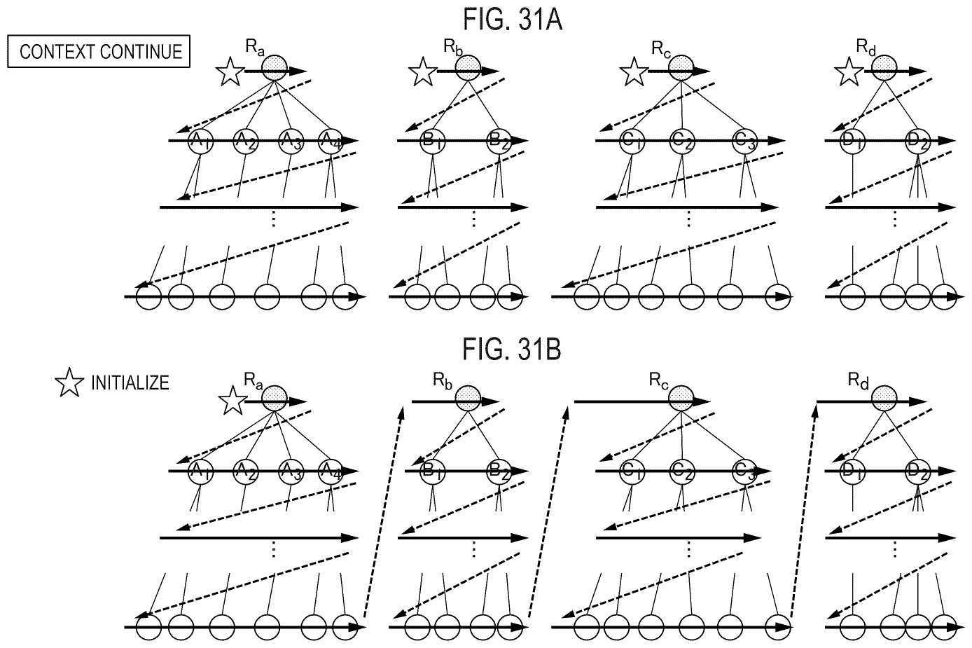

Next, construction of a context at the time of decoding coefficients will be described with reference to FIG. 31 in association with both steps S30003 and S30005.

The context (probability distribution used for arithmetic decoding) for decoding coefficients may be initialized for each tree as illustrated in FIG. 31A.

Here, an arrow in the drawing indicates the order in which context update processing used for coefficient decoding is performed.

The RAHT unit 2080 first decodes DC coefficients→AC coefficients in each root node in this order, and thereafter, decodes the AC coefficients and updates the context one-dimensionally in the breadth first search order.

With the configuration of FIG. 31A, the context is independent for each tree, and thus coefficient decoding processing can be executed in parallel for each tree.

As illustrated in FIG. 31B, the context (probability distribution used for arithmetic decoding) at the time of decoding coefficients may be initialized only once before decoding the first root node, and then sequentially updated in the decoding processing order.

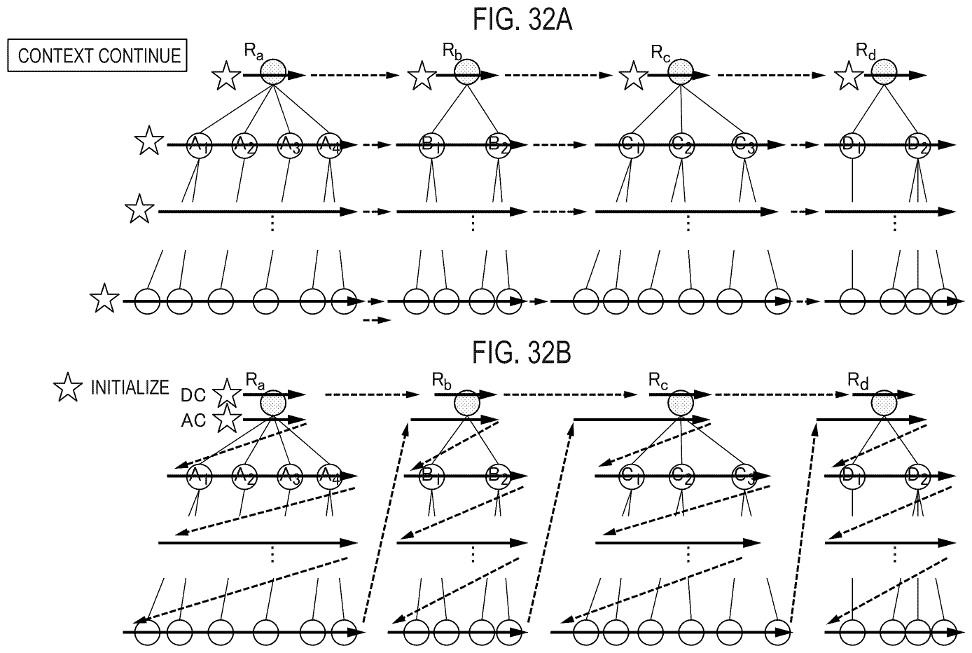

As illustrated in FIG. 32A, the context (probability distribution used for arithmetic decoding) at the time of decoding coefficients may be initialized and updated at the same level between different trees.

In a case where the distribution of the absolute values of the coefficients is different for each level, as illustrated in FIG. 32A, by updating the context (probability distribution) for each level, convergence to the probability distribution suitable for each level becomes easy, and the encoding efficiency can be improved.

As illustrated in FIG. 32B, the context (probability distribution used for arithmetic decoding) at the time of decoding coefficient may be separately initialized and updated in the root node and other nodes.

Further, the RAHT unit 2080 may initialize and update the context separately for the DC coefficient of the root node and other coefficients (AC coefficients of root node and AC coefficients of other nodes).

Since the absolute value of a DC coefficient has a property of being very large as compared with the absolute value of an AC coefficient, separating the context (probability distribution) of the DC coefficient and the AC coefficient converges to a probability distribution suitable for each, and the encoding efficiency can be improved.

The above-described first embodiment and modified examples 1 to 3 can be arbitrarily combined.

The point cloud encoding device 100 and the point cloud decoding device 200 described above may be implemented as programs that cause a computer to execute each function (each step).

In the above embodiments, the present invention has been described using the application to the point cloud encoding device 100 and the point cloud decoding device 200 as an example. However, the present invention is not limited to such examples and can similarly be applied to a point cloud encoding/decoding system that incorporates the respective functions of the point cloud encoding device 100 and the point cloud decoding device 200.

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

What is claimed is:

1. A point cloud decoding device comprising:
a RAHT unit configured to, in inter prediction of an AC coefficient of RAHT, apply a scaling factor to a predicted value of the AC coefficient or a predicted value of an attribute value; and
an attribute information decoding unit configured to derive the number of scaling factors to be used in the inter prediction and decode as many scaling factors as the number.

2. The point cloud decoding device according to claim 1, wherein
the attribute information decoding unit derives the number of scaling factors by using the number of valid hierarchies of inter prediction.

3. The point cloud decoding device according to claim 2, wherein
the attribute information decoding unit:
determines whether to transmit an inter prediction applicability mode for each hierarchy, and
controls a method of deriving the number of valid hierarchies of inter prediction on the basis of the determination result.

4. The point cloud decoding device according to claim 3, wherein
when a result of determination of whether to transmit the inter prediction applicability mode for each hierarchy is “transmit the inter prediction applicability mode for each hierarchy”, the attribute information decoding unit decodes the inter prediction applicability mode for each hierarchy, and derives the number of valid hierarchies of inter prediction on the basis of the inter prediction applicability mode for each hierarchy.

5. The point cloud decoding device according to claim 2, wherein
the attribute information decoding unit derives the number of scaling factors by subtracting a value indicating how many upper layers are excluded from application of scaling of inter prediction from the number of valid hierarchies of inter prediction.

6. A point cloud decoding method, comprising:
in inter prediction of an AC coefficient of RAHT, applying a scaling factor to a predicted value of the AC coefficient or a predicted value of an attribute value; and
deriving the number of scaling factors to be used in the inter prediction and decoding as many scaling factors as the number.

7. A non-transitory computer-readable medium having stored thereon a program for causing a computer to function as a point cloud decoding device,
the point cloud decoding device comprises:
a RAHT unit configured to, in inter prediction of an AC coefficient of RAHT, apply a scaling factor to a predicted value of the AC coefficient or a predicted value of an attribute value; and
an attribute information decoding unit configured to derive the number of scaling factors to be used in the inter prediction and decode as many scaling factors as the number.
